(19) United States
(12) Patent Application Publication
(10) Pub. No.: US 2026/0222809 A1
(43) Pub. Date: Jul. 30, 2026

(54) ENHANCED UE PARAMETERS UPDATE (UPU) PROCEDURES

(71) Applicant: Nokia Technologies Oy, Espoo (FI)

(72) Inventors: Saurabh KHARE, Bangalore (IN); Ranganathan MAVUREDDI DHANASEKARAN, Munich (DE)

(21) Appl. No.: 19/151,507

(22) PCT Filed: Jan. 31, 2024
(86) PCT No.: PCT/IB2024/050893

§ 371 Date: Jul. 28, 2025

Related U.S. Application Data
(60) Provisional application No. 63/442,571, filed on Feb. 1, 2023.

(51) Int. Cl. H04W 12/06; H04W 8/20; H04W 12/72

(52) U.S. Cl. CPC H04W 12/06; H04W 8/20; H04W 12/72

(57) ABSTRACT

Systems, methods, and software of performing a UE parameters update (UPU) of user equipment. In an embodiment, an AUSF receives a UPU protection request message from a UDM regarding the UE parameters update, where the UPU protection request message includes UPU information containing UPU data and a UPU header. The AUSF determines whether the user equipment supports UPU header protection in derivation of message authentication codes based on a UPU header protection indicator in the UPU protection request message. The AUSF derives a message authentication code based on the UPU header when the user equipment supports UPU header protection, and sends a UPU protection response message to the UDM that includes the message authentication code.

### TECHNICAL FIELD

This disclosure is related to the field of communication systems and, in particular, to next generation networks.

### BACKGROUND

Next generation networks, such as Fifth Generation (5G), denote the next major phase of mobile telecommunications standards beyond Fourth Generation (4G) standards. In comparison to 4G networks, next generation networks may be enhanced in terms of radio access and network architecture. Next generation networks intend to utilize new regions of the radio spectrum for Radio Access Networks (RANs), such as millimeter wave bands.

With mobile networks widely used across the country and the world, communications may be intercepted or suffer from other kinds of attacks. To ensure security and privacy, the 3rd Generation Partnership Project (3GPP) has set forth security mechanisms for 5G mobile networks, and the security procedures performed within the 5G mobile networks. One of the security procedures between User Equipment (UE) and a 5G mobile network is primary authentication and key agreement. Primary authentication and key agreement procedures enable mutual authentication between the UE and the network, and provide keying material that can be used between the UE and the serving network in subsequent security procedures.

After primary authentication, configuration parameters of a UE may be updated by the 5G mobile network at any time using a UE Parameters Update (UPU) procedure. However, some of the protection mechanisms used for UE parameters update procedures may be inefficient or not fully defined, and it may be desirable to identify improvements.

### SUMMARY

Described herein are enhanced UE parameters update (UPU) procedures. More particularly, a protection mechanism or scheme for a UE parameters update procedure uses a Message Authentication Code (MAC) to verify or authenticate an update at the UE. However, there is confusion in present UE parameters update procedures over the use of a UPU Header in deriving the MAC, which is also referred to as UPU-MAC-I_{AUSF} in 3GPP Technical Specifications (TS). In a UE parameters update procedure, the Authentication Server Function (AUSF) derives the UPU-MAC-I_{AUSF}, and the UPU-MAC-I_{AUSF} is passed to the UE along with the UPU Data for the update. The UE derives its own version of the UPU-MAC-I_{AUSF}, and compares the derived version of the UPU-MAC-I_{AUSF} with the UPU-MAC-I_{AUSF}received from the network. If they match, then the UE verifies the UE parameters update. In order for MAC verification to pass, the AUSF and the UE need to derive the same UPU-MAC-I_{AUSF}. However, it is not clear in the present UE parameters update procedures whether or not the UPU Header is used to compute the UPU-MAC-I_{AUSF}, as the UPU Header is an optional attribute.

In embodiments described herein, enhanced UE parameters update procedures are set forth where use of a UPU Header in deriving the UPU-MAC-I_{AUSF} is specified. In general, the AUSF is configured to use the UPU Header in computing the UPU-MAC-I_{AUSF}, or is informed by a Unified Data Management (UDM) whether or not to use the UPU Header in computing the UPU-MAC-I_{AUSF}. At the same time, the UE is configured to use the UPU Header in computing the UPU-MAC-I_{AUSF}, or is informed by the 5G core network whether or not to use the UPU Header in computing the UPU-MAC-I_{AUSF}. Thus, there is coordination in the use of the UPU Header for computing the UPU-MAC-I_{AUSF} between the AUSF and the UE. A technical benefit is UE parameters update procedures, and the protection mechanisms within the UE parameters update procedures, are improved.

In an embodiment, an AUSF element of a 5G core network comprises at least one processor, and at least one memory storing instructions that, when executed by the at least one processor, cause the AUSF element at least to receive, for a UE parameters update (UPU) of user equipment, a UPU protection request message from a UDM regarding the UE parameters update for the user equipment, where the UPU protection request message includes UPU information containing UPU data and a UPU header. The at least one processor further causes the AUSF element at least to determine whether the user equipment supports UPU header protection in derivation of message authentication codes based on a UPU header protection indicator in the UPU protection request message, derive a message authentication code based on the UPU header when the user equipment supports UPU header protection, and send a UPU protection response message to the UDM that includes the message authentication code.

In an embodiment, an AUSF element of a 5G core network comprises at least one processor, and at least one memory storing instructions that, when executed by the at least one processor, cause the AUSF element at least to receive, for a UE parameters update (UPU) of user equipment, a UPU protection request message from a UDM regarding the UE parameters update for the user equipment, where the UPU protection request message includes UPU information containing UPU data and a UPU header. The at least one processor further causes the AUSF element at least to derive a first message authentication code based on the UPU data and exclusive of the UPU header, derive a second message authentication code based on the UPU header, and send a UPU protection response message to the UDM that includes the first message authentication code and the second message authentication code.

Other embodiments may include computer readable media, other systems, or other methods as described below. The various features of the different embodiments may be variously combined with some features included and others excluded to suit a variety of different applications.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a high-level architecture of a 5G system.

FIG. 2 illustrates a non-roaming architecture of a 5G system.

FIG. 3 is a signaling diagram that illustrates initiation of primary authentication.

FIG. 4 is a signaling diagram that illustrates an authentication procedure.

FIG. 5 is a signaling diagram that illustrates a UE parameters update procedure.

FIG. 6 is a block diagram of a UDM in an illustrative embodiment.

FIG. 7 is block diagram of an AUSF in an illustrative embodiment.

FIG. 8 is block diagram of an AMF in an illustrative embodiment.

FIG. 9 is block diagram of User Equipment (UE) in an illustrative embodiment.

FIG. 10A is a message diagram illustrating a UE parameters update procedure in an illustrative embodiment.

FIG. 10B illustrates an extension to the Nausf_UPUProtection service to include a UPU header protection indicator in an illustrative embodiment.

FIGS. 11-13 and 14A-14B are flow charts illustrating a method of performing a UE parameters update procedure in an illustrative embodiment.

FIG. 15 is a block diagram illustrating a UPU protection request message for the UPU Protection service in an illustrative embodiment.

FIG. 16 is a block diagram illustrating a UPU protection response message for the UPU Protection service in an illustrative embodiment.

FIGS. 17-18 are a block diagrams illustrating derivation of an AUSF MAC in illustrative embodiments.

FIG. 19 is a block diagram illustrating an SDM notification message for the Subscriber Data Management service in an illustrative embodiment.

FIG. 20 is a block diagram illustrating a UPU transparent container in an illustrative embodiment.

FIG. 21 is a block diagram of a UPU Header of a UPU transparent container in an illustrative embodiment.

FIG. 22 is a block diagram illustrating a UPU transparent container in an illustrative embodiment.

FIG. 23A is a message diagram illustrating a UE parameters update procedure in an illustrative embodiment.

FIG. 23B illustrates an extension to the Nausf_UPUProtection service to include an Enhanced UPU-MAC-I_{AUSF} in an illustrative embodiment.

FIGS. 24-27 are flow charts illustrating a method of performing the UE parameters update procedure in an illustrative embodiment.

FIG. 28 is a block diagram illustrating a UPU protection request message for the UPU Protection service in an illustrative embodiment.

FIG. 29 is a block diagram illustrating a UPU protection response message for the UPU Protection service in an illustrative embodiment.

FIG. 30 is a block diagram illustrating derivation of a conventional AUSF MAC in an illustrative embodiment.

FIG. 31 is a block diagram illustrating derivation of an enhanced AUSF MAC in an illustrative embodiment.

FIG. 32 is a block diagram illustrating an SDM notification message for the Subscriber Data Management service in an illustrative embodiment.

FIG. 33 is a block diagram illustrating a conventional UPU transparent container in an illustrative embodiment.

FIG. 34 is a block diagram illustrating an enhanced UPU transparent container in an illustrative embodiment.

FIG. 35 is a block diagram illustrating a UPU transparent container in an illustrative embodiment.

FIG. 36 illustrates a modified “UpuSecurityInfo” data type for the Nausf_UPU Protection Service API in an illustrative embodiment.

FIG. 37 illustrates a modified “UpuInfo” data type for the Nudm_SubscriberDataManagement Service API in an illustrative embodiment.

FIGS. 38-39 are flow charts illustrating additional details for the method of FIGS. 24-27 in an illustrative embodiment.

FIG. 40 is a block diagram illustrating a UPU protection request message for the UPU Protection service in another illustrative embodiment.

FIG. 41 illustrates a modified “UpuInfo” data type for the Nausf_UPU Protection Service API in an illustrative embodiment.

FIGS. 42A-42B illustrate “enhancedUpuInfo” data types for the Nausf_UPU Protection Service API in an illustrative embodiment.

FIG. 43 illustrates another modified “UpuInfo” data type for the Nausf_UPU Protection Service API in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

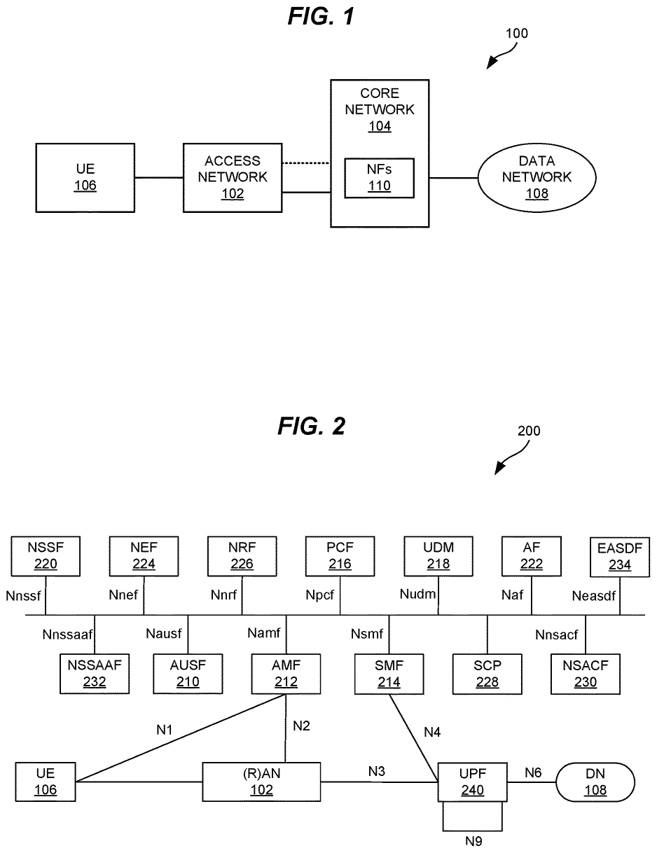

FIG. 1 illustrates a high-level architecture of a 5G system 100. A 5G system (5GS) 100 is a communication system (e.g., a 3GPP system) comprising a 5G Access Network ((R)AN) 102, a 5G core network (5GC) 104, and 5G User Equipment (UE) 106. Access network 102 provides radio or wireless connectivity to UE 106, and connects UE 106 to 5GC 104. Access network 102 may comprise an NG-RAN, a non-3GPP access network, or another type of RAN connecting to 5GC 104. Access network 102 may support Evolved-UMTS Terrestrial Radio Access Network (E-UTRAN) access (e.g., through an eNodeB, gNodeB, and/or ng-eNodeB), Wireless Local Area Network (WLAN) access, fixed access, satellite radio access, new Radio Access Technologies (RAT), etc. 5GC 104 interconnects access network 102 with a data network (DN) 108. 5GC 104 is comprised of Network Functions (NF) 110, which may be implemented either as a network element on dedicated hardware, as a software instance running on dedicated hardware, as a virtualized function instantiated on an appropriate platform (e.g., a cloud infrastructure), etc. Data network 108 may be an operator external public or private data network, or an intra-operator data network (e.g., for IMS services). UE 106 (also referred to as a mobile terminal) is a 5G capable device configured to register with 5GC 104 to access services. UE 106 may be an end user device, such as a mobile phone (e.g., smartphone), a tablet, a computer with a mobile broadband adapter, etc. UE 106 may be enabled for voice services, data services, Machine-to-Machine (M2M) or Machine Type Communications (MTC) services, and/or other services.

FIG. 2 illustrates a non-roaming architecture 200 of a 5G system. The architecture 200 in FIG. 2 is a service-based representation, as is further described in 3GPP TS 23.501 (v18.0.0), which is incorporated by reference as if fully included herein. Architecture 200 is comprised of Network Functions (NF) for a 5GC 104, and the NFs for the control plane (CP) are separated from the user plane (UP). The control plane of the 5GC 104 includes an Authentication Server Function (AUSF) 210, an Access and Mobility Management Function (AMF) 212, a Session Management Function (SMF) 214, a Policy Control Function (PCF) 216, a Unified Data Management (UDM) 218, a Network Slice Selection Function (NSSF) 220, and an Application Function (AF) 222. The control plane of the 5GC 104 further includes a Network Exposure Function (NEF) 224, a NF Repository Function (NRF) 226, a Service Communication Proxy (SCP) 228, a Network Slice Admission Control Function (NSACF) 230, a Network Slice-specific and SNPN Authentication and Authorization Function (NSSAAF) 232, and an Edge Application Server Discovery Function (EASDF) 234. The user plane of the 5GC 104 includes one or more User Plane Functions (UPF) 240 that communicate with data network 108. UE 106 is able to access the control plane and the user plane of the core network 104 through (R)AN 102.

There are a large number of subscribers that are able to access services from a carrier that implements a mobile network comprising a 5G system 100, such as in FIGS. 1-2. Communications between the subscribers (i.e., through a UE) and the mobile network are protected by security mechanisms, such as the ones standardized by the 3GPP. Subscribers and the carrier expect security guarantees from the security mechanisms. One of the security mechanisms is the primary authentication procedure that provides mutual authentication between the UE and the network. The following further illustrates primary authentication.

The purpose of the primary authentication and key agreement procedures is to enable mutual authentication between UE 106 and the network, and provide keying material that can be used between the UE 106 and the serving network in subsequent security procedures. The keying material generated by the primary authentication and key agreement procedure results in an anchor key called the K_{SEAF} key provided by the AUSF 210 of the home network to the Security Anchor Function (SEAF) of the serving network. The SEAF provides authentication functionality via the AMF 212 in the serving network, and supports primary authentication using a Subscription Concealed Identifier (SUCI) that contains the concealed Subscription Permanent Identifier (SUPI). The SUPI is a globally unique 5G identifier allocated to each subscriber in the 5G system 100. The SUCI is composed a SUPI type, a Home Network Identifier (HN-ID) identifying the home network of the subscriber, a Routing Indicator (RID) that is assigned to the subscriber by the home network operator and provisioned in the Universal Subscriber Identity Module (USIM) of the UE, a Protection Scheme Identifier, a Home Network Public Key Identifier, and a Scheme Output. The anchor key K_{SEAF} is derived from an intermediate key called the K_{AUSF} key. The K_{AUSF} key is established between the UE 106 and the home network resulting from the primary authentication procedure.

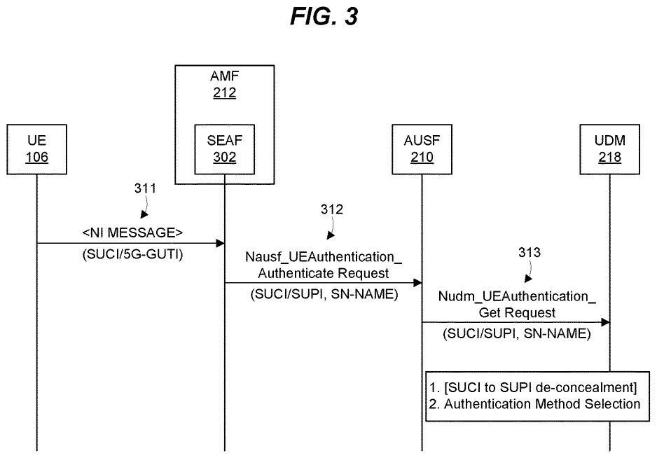

FIG. 3 is a signaling diagram that illustrates initiation of primary authentication, such as described in 3GPP TS 33.501 (v18.0.0), which is incorporated by reference as if fully included herein. UE 106 transmits an N1 message 311 (i.e., an initial Non-Access Stratum (NAS) message) to the serving network (e.g., the AMF 212 of the serving network), such as a Registration Request. UE 106 uses the SUCI or a 5G Global Unique Temporary Identifier (5G-GUTI) in the Registration Request. SEAF 302 of the AMF 212 may initiate an authentication with UE 106 during any procedure establishing a signaling connection with UE 106. SEAF 302 invokes the Nausf_UEAuthentication service by sending a Nausf_UEAuthentication_Authenticate Request message 312 to AUSF 210 to initiate an authentication. The Nausf_UEAuthentication_Authenticate Request message 312 includes the SUCI or SUPI, and the serving network name (SN-Name). Upon receiving the Nausf_UEAuthentication_Authenticate Request message 312, AUSF 210 checks that the requesting SEAF 302 in the serving network is entitled to use the serving network name in the Nausf_UEAuthentication_Authenticate Request message 312 by comparing the serving network name with the expected serving network name. When the serving network is authorized to use the serving network name, AUSF 210 sends a Nudm_UEAuthentication_Get Request message 313 to UDM 218. The Nudm_UEAuthentication_Get Request message 313 includes the SUCI or SUPI, and the serving network name. Upon reception of the Nudm_UEAuthentication_Get Request message 313, UDM 218 identifies the SUPI (if received), or invokes a Subscription Identifier De-concealing Function (SIDF) that de-conceals the SUPI from the SUCI (if received). UDM 218 (or an Authentication credential Repository and Processing Function (ARPF) of UDM 218) selects or chooses the authentication method for primary authentication based on the SUPI.

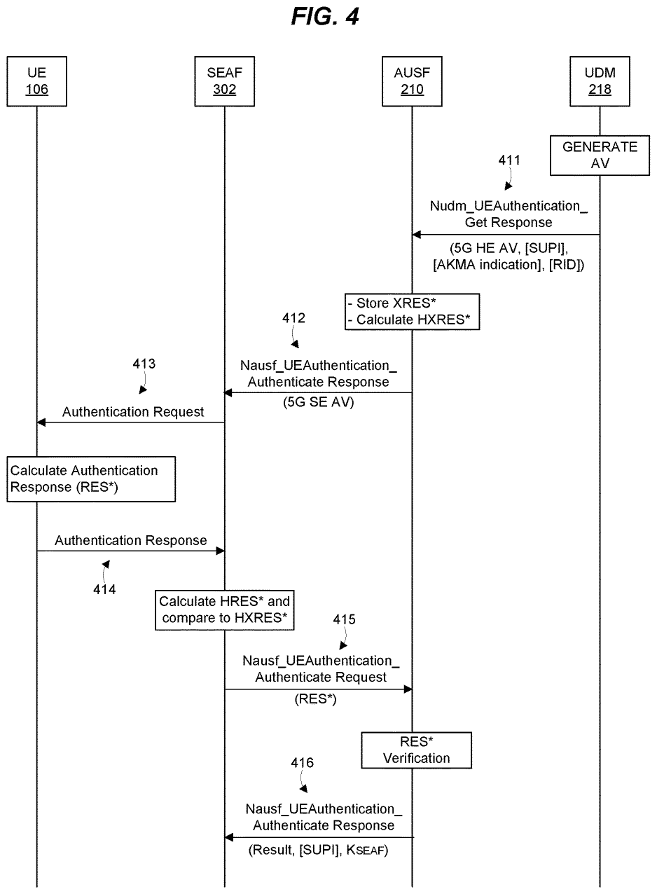

FIG. 4 is a signaling diagram that illustrates a primary authentication procedure, such as described in 3GPP TS 33.501. In this example, 5G Authentication and Key Agreement (AKA) is described, but similar concepts apply for Extensible Authentication Protocol AKA (EAP-AKA′). For a Nudm_UEAuthentication_Get Request, UDM 218 creates a 5G Home Environment Authentication Vector (5G HE AV) for the selected authentication method. UDM 218 derives the K_{AUSF} key and calculates an expected response (XRES*) to a challenge. UDM 218 creates the 5G HE AV comprising an authentication token (AUTN), the expected response (XRES*), the K_{AUSF} key, and a random challenge (RAND). UDM 218 then sends a Nudm_UEAuthentication_Get Response message 411 to AUSF 210 with the 5G HE AV to be used for authentication (e.g., 5G AKA in FIG. 4). In case the SUCI was included in the Nudm_UEAuthentication_Get Request, UDM 218 includes the SUPI in the Nudm_UEAuthentication_Get Response message 411 after de-concealment of the SUPI from the SUCI. If a subscriber has an Authentication and Key Management for Application (AKMA) subscription, UDM 218 includes an AKMA indication and the RID in the Nudm_UEAuthentication_Get Response message 411.

In response to the Nudm_UEAuthentication_Get Response message 411, AUSF 210 stores the expected response (XRES*) temporarily with the received SUCI or SUPI. AUSF 210 then generates a 5G Authentication Vector (5G AV) from the 5G HE AV received from UDM 218, by computing a hash expected response (HXRES*) from the expected response (XRES*) and the K_{SEAF} key from the K_{AUSF} key, and replacing the XRES* with the HXRES* and the K_{AUSF} key with the K_{SEAF} key in the 5G HE AV. AUSF 210 removes the K_{SEAF} key to generate a 5G Serving Environment Authentication Vector (5G SE AV) that includes the authentication token (AUTN), hash expected response (HXRES*), and the random challenge (RAND). AUSF 210 sends a Nausf_UEAuthentication_Authenticate Response message 412 to SEAF 302 that includes the 5G SE AV. In response, SEAF 302 sends the authentication token (AUTN) and the random challenge (RAND) to UE 106 in a NAS message Authentication Request message 413.

Although not shown in FIG. 4, UE 106 includes Mobile Equipment (ME) and a USIM. The ME receives the authentication token (AUTN) and the random challenge (RAND) in the NAS message Authentication Request message 413, and forwards the authentication token (AUTN) and the random challenge (RAND) to the USIM. The USIM of UE 106 verifies the freshness of the received values by checking whether the authentication token (AUTN) can be accepted. If so, the USIM computes a response (RES), a cipher key (CK), and an integrity key (IK) based on the random challenge (RAND), and returns the response (RES), the CK key, and the IK key to the ME. The ME of UE 106 computes RES* from RES, and calculates the K_{AUSF} key from CK∥IK and the K_{SEAF} key from the K_{AUSF} key.

UE 106 sends a NAS message Authentication Response message 414 to SEAF 302 that includes RES*. In response, SEAF 302 computes HRES* from RES*, and compares HRES* and HXRES*. If they coincide, SEAF 302 considers the authentication successful from the serving network point of view. SEAF 302 sends RES*, as received from UE 106, in a Nausf_UEAuthentication_Authenticate Request message 415 to AUSF 210. When AUSF 210 receives the Nausf_UEAuthentication_Authenticate Request message 415 including a RES* as authentication confirmation, AUSF 210 stores the K_{AUSF} key based on the home network operator's policy, and compares the received RES* with the stored XRES*. If the RES* and XRES* are equal, then AUSF 210 considers the authentication successful from the home network point of view. AUSF 210 informs UDM 218 about the authentication result (not shown). AUSF 210 also sends a Nausf_UEAuthentication_Authenticate Response message 416 to SEAF 302 indicating whether or not the authentication was successful from the home network point of view. If the authentication was successful, the K_{SEAF} key is sent to SEAF 302 in the Nausf_UEAuthentication_Authenticate Response message 416. In case AUSF 210 received the SUCI from SEAF 302 in the authentication request, AUSF 210 includes the SUPI in the Nausf_UEAuthentication_Authenticate Response message 416 if the authentication was successful.

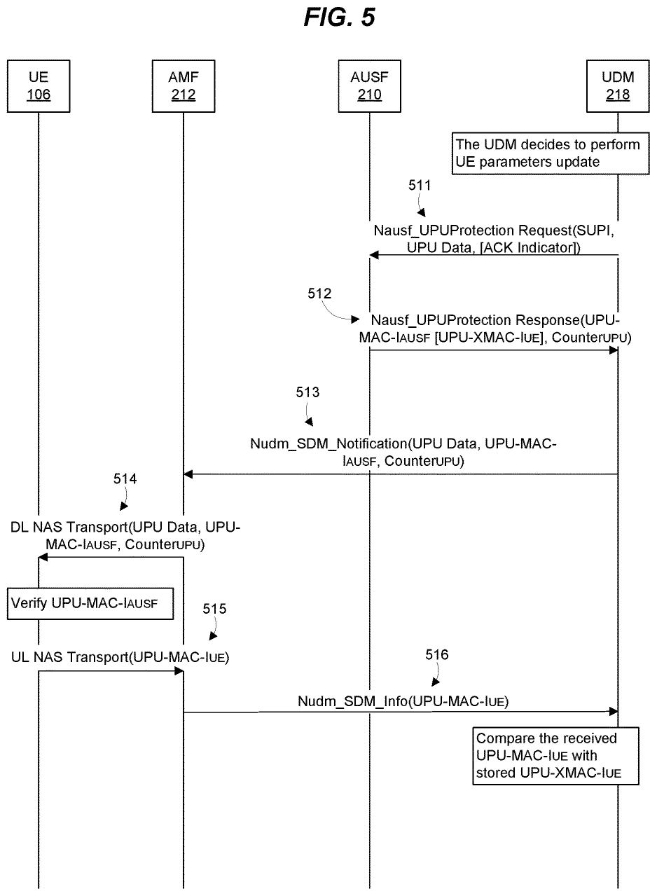

UE Parameters Update (UPU) is a procedure in 5G between UEs and the home network. The UE parameters update procedure enables the home network to update one or more configuration parameters (i.e., UE parameters) in a UE and/or USIM using control plane signaling. UDM 218, for example, may decide to perform a UE parameters update anytime after a UE 106 has been successfully authenticated and registered to the 5G system 100, as described in section 6.15.2 of 3GPP TS 33.501. FIG. 5 is a signaling diagram that illustrates a UE parameters update procedure. In an example, UDM 218 decides to perform a UE Parameters Update (UPU) procedure using the control plane procedure while the UE 106 is registered to the 5G system 100. If the final consumer of any of the UE parameters to be updated (e.g., updated RID) is the USIM of a UE 106, UDM 218 protects these parameters using a secured packet mechanism to update the parameters stored on the USIM. UDM 218 prepares the UE Parameters Update Data (UPU Data) by including the parameters protected by the secured packet, if any, as well as any UE parameters for which final consumer is the ME of the UE 106.

AUSF 210 offers a UPUProtection service as described in 3GPP TS 29.509 (v18.0.0), which is incorporated by reference as if fully included herein. AUSF 210 acts as an NF Service Producer that provides the UPUProtection service to an NF Service Consumer. The UPUProtection service provides the NF Service Consumer (e.g., UDM 218) with the UPU-MAC-I_{AUSF} and Counter_{UPU} to protect the UPU Data from being tampered with or removed. Optionally, the UPUProtection service also provides the NF Service Consumer (e.g., UDM 218) with the UPU-XMAC-I_{UE} that allows the NF Service Consumer to verify that the UE 106 received UPU Data correctly. UDM 218 invokes the Nausf_UPUProtection service by sending a Nausf_UPUProtection Request message 511 to AUSF 210 to get the UPU-MAC-I_{AUSF} and Counter_{UPU}. UDM 218 includes the SUPI and the UPU Data in the Nausf_UPUProtection Request message 511. If UDM 218 decided that the UE 106 is to acknowledge the successful security check of the received UPU Data, then UDM 218 sets the corresponding indication in the UPU Data and includes an ACK Indication in the Nausf_UPUProtection Request message 511 to signal that it also needs the expected UPU-XMAC-I_{UE}.

AUSF 210 computes or derives the UPU-MAC-I_{AUSF} using UE specific home key (K_{AUSF}) along with the UPU Data received from UDM 218, and delivers the UPU-MAC-I_{AUSF} and the CounterUPU to UDM 218 in a Nausf_UPUProtection Response message 512. If the ACK Indication is present in the Nausf_UPUProtection Request message 511, then AUSF 210 computes or derives the UPU-XMAC-I_{UE} and returns the computed UPU-XMAC-I_{UE} in the Nausf_UPUProtection Response message 512. The expected UPU-XMAC-I_{UE} allows UDM 218 to verify that the UE 106 received the UPU Data correctly.

UDM 218 then invokes the Nudm_SDM_Notification service operation, and transmits an Nudm_SDM_Notification message 513 to AMF 212 which includes the UPU transparent container if AMF 212 supports UPU transparent containers, or includes individual Information Elements (IEs) comprising the UPU Data, the UPU-MAC-I_{AUSF}, and the Counter_{UPU}. If UDM 218 requests an acknowledgement, it temporarily stores the expected UPU-XMAC-I_{UE}. Upon receiving the Nudm_SDM_Notification message 513, AMF 212 sends a Downlink (DL) NAS Transport message 514 to UE 106. AMF 212 includes the transparent container in the DL NAS Transport message 514 if received from UDM 218. Otherwise, if UDM 218 provided individual IEs, then AMF 212 constructs a UPU transparent container.

On receiving the DL NAS Transport message 514, UE 106 calculates the UPU-MAC-I_{AUSF} in the same way as AUSF 210 based on the received UPU Data and the Counter_{UPU}, and verifies whether it matches the UPU-MAC-I_{AUSF} value received in the DL NAS Transport message 514 (i.e., within the transparent container). If the verification of UPU-MAC-I_{AUSF} is successful and the UPU Data contains any parameters that are protected by secured packet, then the ME of UE 106 forwards the secured packet to the USIM. If the verification of UPU-MAC-I_{AUSF} is successful and the UPU Data contains any parameters that are not protected by secured packet, then the ME of UE 106 updates its stored parameters with the received parameters in UDM Updata Data.

If UDM 218 has requested an acknowledgement from UE 106 and UE 106 has successfully verified and updated the UPU Data provided by UDM 218, then UE 106 sends an Uplink (UL) NAS Transport message 515 to the serving AMF 212. UE 106 generates the UPU-MAC-I_{UE}, and includes the generated UPU-MAC-I_{UE} in a transparent container in the UL NAS Transport message 515. AMF 212 sends a Nudm_SDM_Info message 516 with the UPU-MAC-I_{UE} to UDM 218. If a transparent container with the UPU-MAC-I_{UE} was received in the UL NAS Transport message 515, then AMF 212 sends the Nudm_SDM_Info message 516 with the transparent container to the UDM 218. If UDM 218 indicated that UE 106 is to acknowledge the successful security check of the received UPU Data, then UDM 218 compares the received UPU-MAC-I_{UE} with the expected UPU-XMAC-I_{UE} that UDM 218 stored temporarily to verify that UE 106 successfully received the UPU data.

For the UPU operation, AUSF 210 and UE 106 associate a 16-bit counter, Counter_{UPU}, with the K_{AUSF} key, and maintain the Counter_{UPU} for the lifetime of the K_{AUSF} key. UE 106 initializes the Counter_{UPU} to 0x00 0x00 when the newly derived K_{AUSF} key is stored, and stores the Counter_{UPU}. If the USIM of UE 106 supports both 5G parameters storage and 5G parameters extended storage, then the Counter_{UPU} is stored in the USIM. Otherwise, the Counter_{UPU} is stored in the non-volatile memory of the ME.

To generate the UPU-MAC-I_{AUSF}, AUSF 210 uses the Counter_{UPU}. The Counter_{UPU} is incremented by AUSF 210 for every new computation of the UPU-MAC-I_{AUSF}. The Counter_{UPU} is used as freshness input into UPU-MAC-I_{AUSF} and UPU-MAC-I_{UE} derivations to mitigate a replay attack. AUSF 210 sends the value of the Counter_{UPU} (used to generate the UPU-MAC-I_{AUSF}) along with the UPU-MAC-I_{AUSF} to UE 106. UE 106 only accepts the Counter_{UPU} value that is greater than the stored Counter_{UPU} value. UE 106 updates the stored Counter_{UPU} with the received Counter_{UPU}, if the verification of the received UPU-MAC-I_{AUSF} is successful. UE 106 uses the Counter_{UPU} received from UDM 218 when deriving the UPU-MAC-I_{UE} for the UPU acknowledgement.

AUSF 210, that supports the UE parameters update using control plane procedure, initializes the Counter_{UPU} to 0x00 0x01 when the newly derived K_{AUSF} is stored. AUSF 210 sets the Counter_{UPU} to 0x00 0x02 after the first calculated UPU-MAC-I_{AUSF}, and monotonically increments the Counter_{UPU} for each additional calculated UPU-MAC-I_{AUSF}. AUSF 210 suspends the UE Parameters Update protection service for the UE 106 if the Counter_{UPU} associated with the K_{AUSF} of UE 106 is about to wrap around. When a fresh K_{AUSF} is generated for the UE 106, the Counter_{UPU} at AUSF 210 is reset to 0x00 0x01 as defined above and AUSF 210 resumes the UE Parameters Update protection service for the UE 106.

An issue with the present UE parameters update procedure is confusion over the use of a UPU Header in deriving the UPU-MAC-I_{AUSF}. In general, message authentication methods at the control plane use a Message Authentication Code (MAC) to verify the authentication of a message. For example, a device that receives a message derives a MAC for the received message, and compares the derived MAC with a received MAC received in the message. If the MACs agree, then the message is authenticated. If the MACs disagree, then the message is typically discarded and a re-transmission is requested. In order for MAC verification to pass during a UE parameters update procedure, AUSF 210 and UE 106 need to derive the same MAC (UPU-MAC-I_{AUSF}) from the same data. However, the data model for the UPU Protection service as described in 3GPP TS 29.509 provides for an optional UPU Header (see section 6.3.6.2.2). Thus, a UDM 218 may or may not send a UPU Header to the AUSF 210 when requesting the UPU-MAC-I_{AUSF} and Counter_{UPU}. This leads to confusion as to whether the AUSF 210 is to derive the UPU-MAC-I_{AUSF} based on the UPU Header.

If, for example, AUSF 210 derives the UPU-MAC-I_{AUSF} based on the UPU Data, then the UPU Data is protected by the UPU-MAC-I_{AUSF}. In other words, the UE 106 can verify the UPU Data based on the UPU-MAC-I_{AUSF}. However, it may be beneficial to protect the UPU Header. In order the protect the UPU Header in a similar manner to the UPU Data, an AUSF 210 would derive the UPU-MAC-I_{AUSF} based on the UPU Header.

In embodiments described herein, enhanced UE parameters update procedures are set forth between a 5G system 100 and a UE 106 in generating a MAC. As described herein, a MAC generated by an AUSF 210 and verified by a UE 106 may be referred to as an AUSF MAC (e.g., UPU-MAC-I_{AUSF}), a first MAC, a first UPU MAC, etc. A MAC generated by a UE 106 and verified by a UDM 218 may be referred to as a UE MAC (e.g., UPU-MAC-I_{UE}), a second MAC, a second UPU MAC, etc.

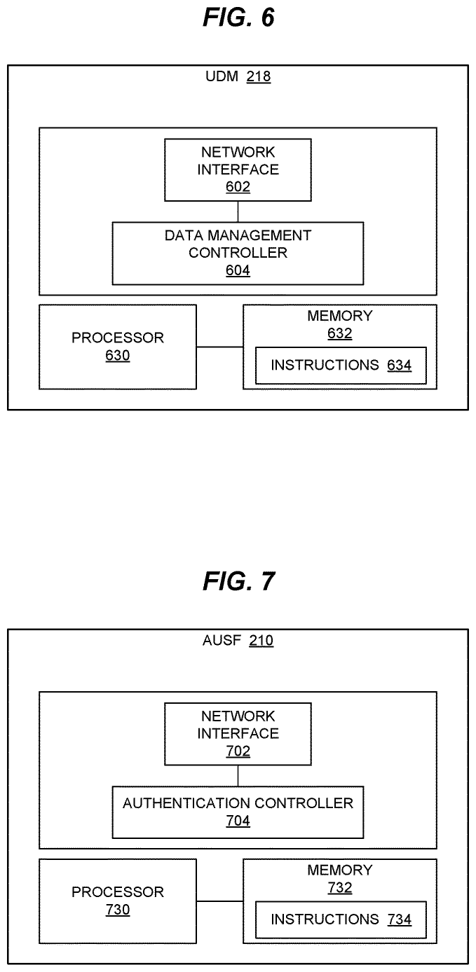

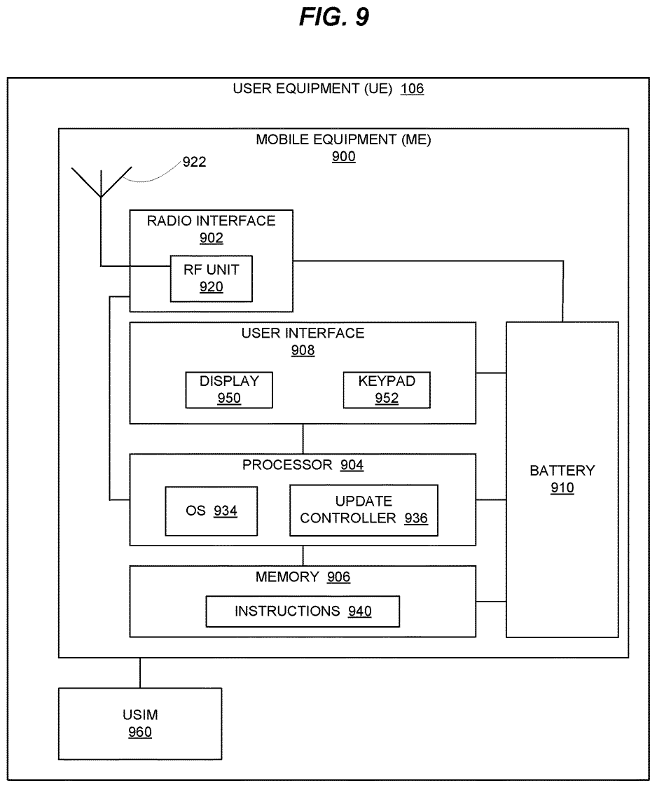

In general, the network functions for UE parameters update procedures include a UDM 218, an AUSF 210, and an AMF 212. Block diagrams for these network functions are provided in FIGS. 6-8. A block diagram of a UE 106 is provided in FIG. 9

FIG. 6 is a block diagram of a UDM 218 in an illustrative embodiment. UDM 218 is a network element or network function configured to manage network user data within the 5G core network 104. In this embodiment, UDM 218 includes the following subsystems: a network interface component 602, and a data management controller 604 that operate on one or more platforms. Network interface component 602 may comprise circuitry, logic, hardware, means, etc., configured to exchange control plane messages or signaling with other network elements and/or UEs. Network interface component 602 may operate using a variety of protocols or reference points. Data management controller 604 may comprise circuitry, logic, hardware, means, etc., configured to support services, operations, procedures, or functions of a UDM.

One or more of the subsystems of UDM 218 may be implemented on a hardware platform comprised of analog and/or digital circuitry. For example, data management controller 604 may be implemented on one or more processors 630 that execute instructions 634 (i.e., computer readable code) for software that are loaded into memory 632. A processor 630 comprises an integrated hardware circuit configured to execute instructions 634 to provide the functions of UDM 218. Processor 630 may comprise a set of one or more processors or may comprise a multi-processor core, depending on the particular implementation. Memory 632 is a non-transitory computer readable storage medium for data, instructions, applications, etc., and is accessible by processor 630. Memory 632 is a hardware storage device capable of storing information on a temporary basis and/or a permanent basis. Memory 632 may comprise a random-access memory, or any other volatile or non-volatile storage device. One or more of the subsystems of UDM 218 may be implemented on a cloud-computing platform or another type of processing platform.

UDM 218 may include various other components not specifically illustrated in FIG. 6.

FIG. 7 is block diagram of an AUSF 210 in an illustrative embodiment. AUSF 210 is a network element or network function configured to perform authentication with a UE. In this embodiment, AUSF 210 includes the following subsystems: a network interface component 702, and an authentication controller 704 that operate on one or more platforms. Network interface component 702 may comprise circuitry, logic, hardware, means, etc., configured to exchange control plane messages or signaling with other network elements and/or UEs. Network interface component 702 may operate using a variety of protocols or reference points. Authentication controller 704 may comprise circuitry, logic, hardware, means, etc., configured to support operations, procedures, or functions of an AUSF.

One or more of the subsystems of AUSF 210 may be implemented on a hardware platform comprised of analog and/or digital circuitry. One or more of the subsystems of AUSF 210 may be implemented on one or more processors 730 that execute instructions 734 (i.e., computer readable code) for software that are loaded into memory 732. One or more of the subsystems of AUSF 210 may be implemented on a cloud-computing platform or another type of processing platform.

AUSF 210 may include various other components not specifically illustrated in FIG. 7.

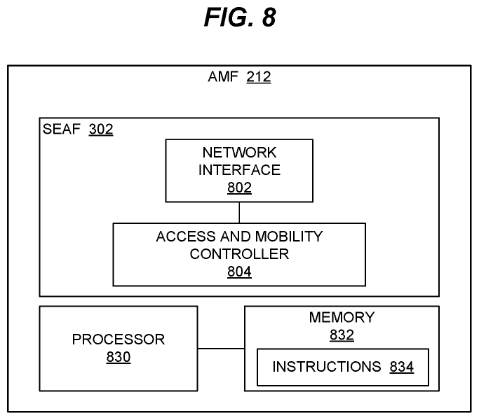

FIG. 8 is block diagram of an AMF 212 in an illustrative embodiment. AMF 212 is a network element or network function configured provide registration management of a UE. In this embodiment, AMF 212 includes the following subsystems: a network interface component 802, and an access and mobility controller 804 that operate on one or more platforms. Network interface component 802 may comprise circuitry, logic, hardware, means, etc., configured to exchange control plane messages or signaling with other network elements and/or UEs. Network interface component 802 may operate using a variety of protocols or reference points. Access and mobility controller 804 may comprise circuitry, logic, hardware, means, etc., configured to support operations, procedures, or functions of an AMF.

One or more of the subsystems of AMF 212 may be implemented on a hardware platform comprised of analog and/or digital circuitry. One or more of the subsystems of AMF 212 may be implemented on one or more processors 830 that execute instructions 834 (i.e., computer readable code) for software that are loaded into memory 832. One or more of the subsystems of AMF 212 may be implemented on a cloud-computing platform or another type of processing platform.

AMF 212 may include various other components not specifically illustrated in FIG. 8.

FIG. 9 is a block diagram of a UE 106 in an illustrative embodiment. From a functional standpoint, UE 106 is composed of at least two parts: Mobile Equipment (ME) 900 and a Universal Subscriber Identity Module (USIM) 960. ME 900 includes a radio interface component 902, one or more processors 904, a memory 906, a user interface component 908. UE 106 may also comprise a battery 910. Radio interface component 902 is a hardware component that represents the local radio resources of UE 106, such as an RF unit 920 (e.g., one or more radio transceivers) and one or more antennas 922. Radio interface component 902 may be configured for WiFi, Bluetooth, 5G NR, LTE, etc. Processor 904 represents the internal circuitry, logic, hardware, means, etc., that provides the functions of UE 106. Processor 904 may be configured to execute instructions 940 for software that are loaded into memory 906. Processor 904 may execute an Operating System (OS) 934 for UE 106 that manages hardware and software resources, and one or more applications. Processor 904 may implement an update controller 936 configured to perform a UE parameters update. User interface component 908 is a hardware component for interacting with an end user. For example, user interface component 908 may include a display 950, screen, touch screen, or the like (e.g., a Liquid Crystal Display (LCD), a Light Emitting Diode (LED) display, etc.). User interface component 908 may include a keyboard or keypad 952, a tracking device (e.g., a trackball or trackpad), a speaker, a microphone, etc.

USIM 960 is an integrated circuit that provides security and integrity functions for UE 106. USIM 960 includes or is provisioned with a subscription profile associated with a subscription of a subscriber. A subscription profile may include a variety of information, such as subscription credentials (e.g., SUPI) used to uniquely identify a subscription and to mutually authenticate the UE 106 and a network.

UE 106 may include various other components not specifically illustrated in FIG. 9.

### Embodiment 1

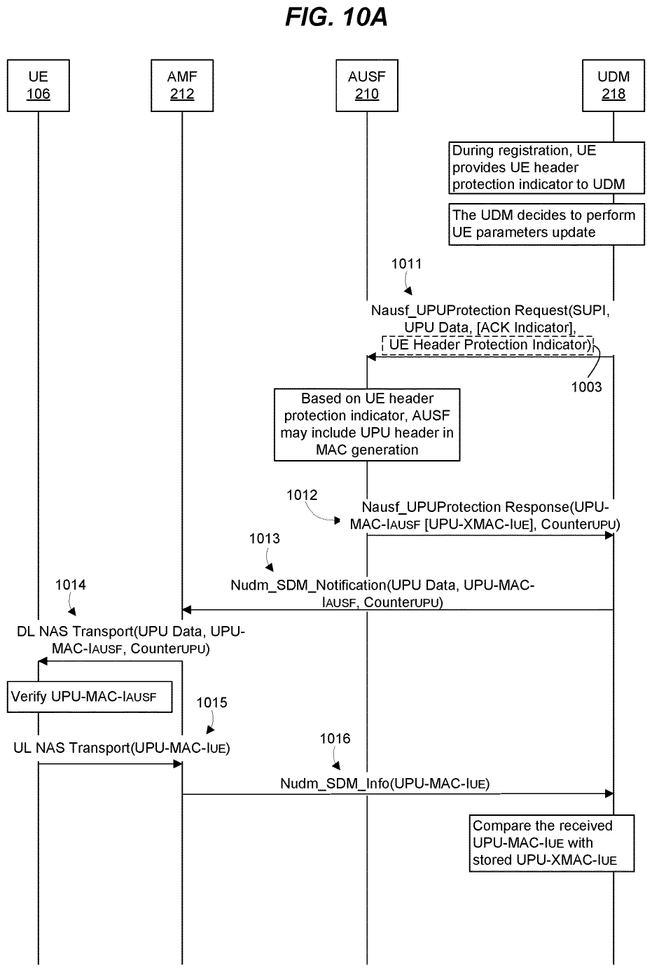

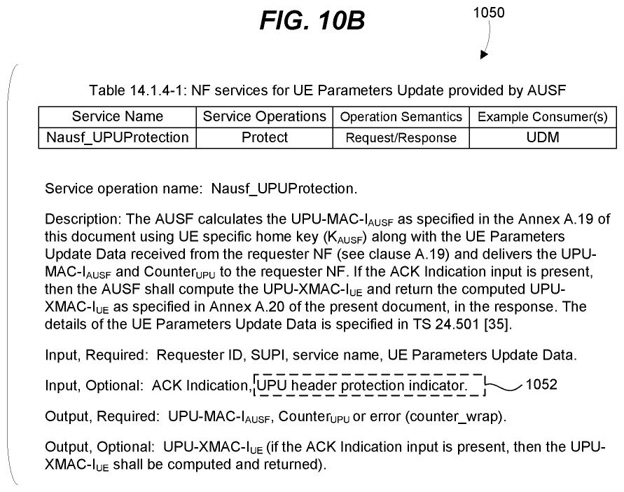

FIG. 10A is a message diagram illustrating a UE parameters update procedure in an illustrative embodiment. The UE parameters update procedure described in FIG. 10A may be an extension to section 6.15.2.1 of 3GPP TS 33.501. As a general overview, a UPU Header may be protected in a UE parameters update, and used in the derivation of an AUSF MAC depending on the capabilities of a UE 106. If the UE 106 supports UPU header protection, then an AUSF 210 and UE 106 may derive an AUSF MAC based on the UPU Header. UPU header protection is a protection scheme, mechanism, method, or procedure where an AUSF MAC is derived based, at least in part, on a UPU Header. One technical benefit is the UPU Header may be protected in the UE parameters update, along with any other UPU Information (e.g., UPU Data) used to derive the AUSF MAC. If the UE 106 does not support UPU header protection, then an AUSF 210 and UE 106 may derive an AUSF MAC not based on the UPU Header. One technical benefit is existing UEs can still perform a UE parameters update based on the UPU Data.

In an embodiment, during the NAS Registration of UE 106, the UE 106 provides a UPU header protection indicator to AMF 212. AMF 212 includes the UPU header protection indicator in an authentication or registration message, and provides the UPU header protection indicator to UDM 218. UDM 218 stores the UPU header protection indicator, such as in the Unified Data Repository (UDR). UDM 218 decides to perform the UE Parameters Update (UPU) using the control plane procedure while the UE 106 is registered to the 5G system 100. If the final consumer of any of the UE parameters to be updated (e.g., updated RID) is the USIM of a UE 106, UDM 218 protects these parameters using a secured packet mechanism to update the parameters stored on the USIM. UDM 218 prepares the UE Parameters Update Data (UPU Data) by including the parameters protected by the secured packet, if any, as well as any UE parameters for which final consumer is the ME of the UE 106.

UDM 218 invokes the Nausf_UPUProtection service by sending a Nausf_UPUProtection Request message 1011 to AUSF 210 to get the UPU-MAC-I_{AUSF} and Counter_{UPU}. UDM 218 includes the SUPI and the UPU Data in the Nausf_UPUProtection Request message 1011. If UDM 218 decided that the UE 106 is to acknowledge the successful security check of the received UPU Data, then UDM 218 sets the corresponding indication in the UPU Data and includes an ACK Indication in the Nausf_UPUProtection Request message 1011 to signal that it also needs the expected UPU-XMAC-I_{UE}. If the stored UPU header protection indicator 1003 for the UE 106 is set to true, for example, then UDM 218 also includes the UPU header protection indicator 1003 in the Nausf_UPUProtection service operation (i.e., in the Nausf_UPUProtection Request message 1011).

AUSF 210 computes or derives the UPU-MAC-I_{AUSF} using UE specific home key (K_{AUSF}), and delivers the UPU-MAC-I_{AUSF} and the Counter_{UPU} to UDM 218 in a Nausf_UPUProtection Response message 1012. When the UPU header protection indicator 1003 is present and set to true in the Nausf_UPUProtection Request message 1011 (i.e., UE 106 supports UPU header protection), AUSF 210 computes or derives the UPU-MAC-I_{AUSF} based, at least in part, on the UPU Header. The inclusion of the UPU Header in the calculation of UPU-MAC-I_{AUSF} allows the UE 106 to verify that the UPU Header has not been tampered by any intermediary. When the UPU header protection indicator 1003 is not present or set to false, for example, in the Nausf_UPUProtection Request message 1011, AUSF 210 computes or derives the UPU-MAC-I_{AUSF} based on the UPU Data and exclusive of the UPU Header. The inclusion of the UPU Data in the calculation of UPU-MAC-I_{AUSF} allows the UE 106 to verify that the UPU Data has not been tampered by any intermediary. If the ACK Indication is present in the Nausf_UPUProtection Request message 1011, then AUSF 210 computes or derives the UPU-XMAC-I_{UE} and returns the computed UPU-XMAC-I_{UE} in the Nausf_UPUProtection Response message 1012. The expected UPU-XMAC-I_{UE} allows UDM 218 to verify that the UE 106 received the UPU Data correctly.

UDM 218 then invokes the Nudm_SDM_Notification service operation, and transmits an Nudm_SDM_Notification message 1013 to AMF 212 which includes the UPU transparent container if AMF 212 supports UPU transparent containers, or includes individual Information Elements (IEs) comprising the UPU Data, the UPU-MAC-I_{AUSF}, and the Counter_{UPU}. If UDM 218 requests an acknowledgement, it temporarily stores the expected UPU-XMAC-I_{UE}. Upon receiving the Nudm_SDM_Notification message 1013, AMF 212 sends a DL NAS Transport message 1014 to UE 106. AMF 212 includes the transparent container in the DL NAS Transport message 1014 if received from UDM 218. Otherwise, if UDM 218 provided individual IEs, then AMF 212 constructs a UPU transparent container.

On receiving the DL NAS Transport message 1014, UE 106 calculates the UPU-MAC-I_{AUSF} in the same way as AUSF 210 based on the received UPU Data and the Counter_{UPU}, and verifies whether it matches the UPU-MAC-I_{AUSF} value received in the DL NAS Transport message 1014 (i.e., within the transparent container). If the verification of UPU-MAC-I_{AUSF} is successful and the UPU Data contains any parameters that are protected by secured packet, then the ME of UE 106 forwards the secured packet to the USIM. If the verification of UPU-MAC-I_{AUSF} is successful and the UPU Data contains any parameters that are not protected by secured packet, then the ME of UE 106 updates its stored parameters with the received parameters in UDM Updata Data.

If UDM 218 has requested an acknowledgement from UE 106 and UE 106 has successfully verified and updated the UPU Data provided by UDM 218, then UE 106 sends a UL NAS Transport message 1015 to the serving AMF 212. UE 106 generates the UPU-MAC-I_{UE}, and includes the generated UPU-MAC-I_{UE} in a transparent container in the UL NAS Transport message 1015. AMF 212 sends a Nudm_SDM_Info message 1016 with the UPU-MAC-I_{UE} to UDM 218. If a transparent container with the UPU-MAC-I_{UE} was received in the UL NAS Transport message 1015, then AMF 212 sends the Nudm_SDM_Info message 1016 with the transparent container to the UDM 218. If UDM 218 indicated that UE 106 is to acknowledge the successful security check of the received UPU Data, then UDM 218 compares the received UPU-MAC-I_{UE} with the expected UPU-XMAC-I_{UE} that UDM 218 stored temporarily to verify that UE 106 successfully received the UPU data.

To provide the UPU header protection indicator 1003 to AUSF 210, the UPU Protection service (e.g., Nausf_UPUProtection service) may be extended. FIG. 10B illustrates an extension 1050 to the Nausf_UPUProtection service to include a UPU header protection indicator 1003 in an illustrative embodiment. As described in section 14.1.4 of 3GPP TS 33.501, the Nausf_UPUProtection service specifies the following as required input: Requester ID, SUPI, service name, UPU Data. The Nausf_UPUProtection service specifies the ACK indicator as optional input. In an embodiment, the UPU header protection indicator 1003 is included as an optional input 1052 to the Nausf_UPUProtection service. For example, the UPU header protection indicator 1003 may be set to “true” or “1” when a UE 106 supports UPU header protection. The UPU header protection indicator 1003 may be set to “false” or “0”, or may be omitted, when a UE 106 does not support UPU header protection. One technical benefit is the UDM 218 is able to inform AUSF 210 whether or not to derive the UPU-MAC-I_{AUSF} based on the UPU Header according to the UPU header protection indicator 1003.

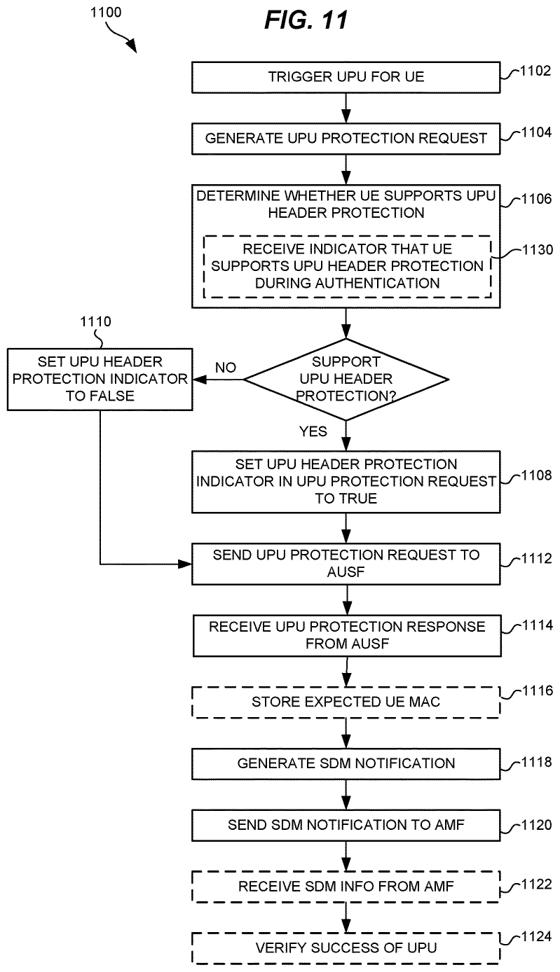

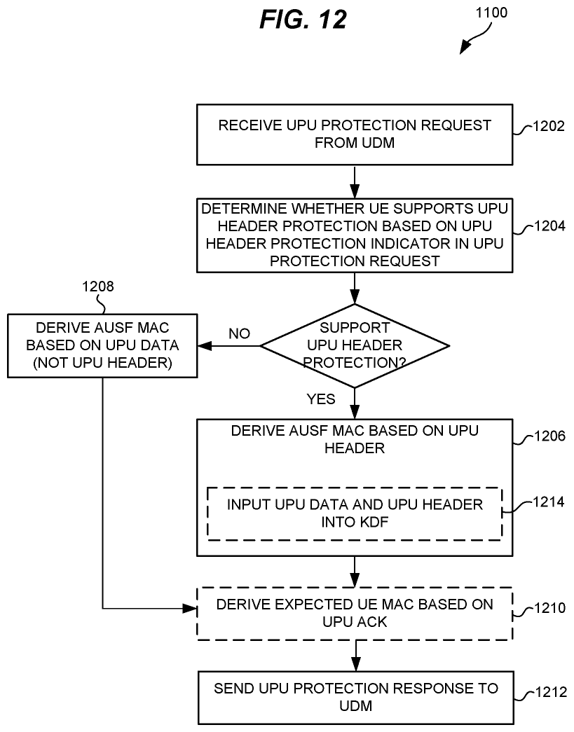

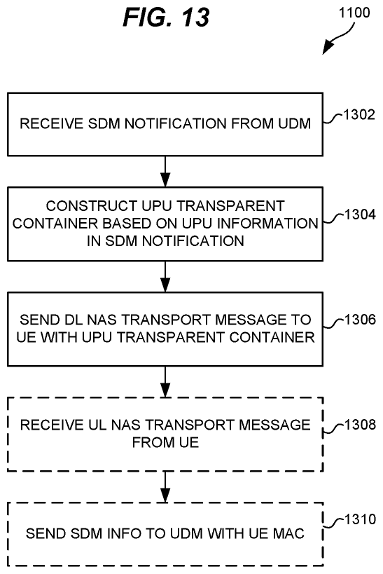

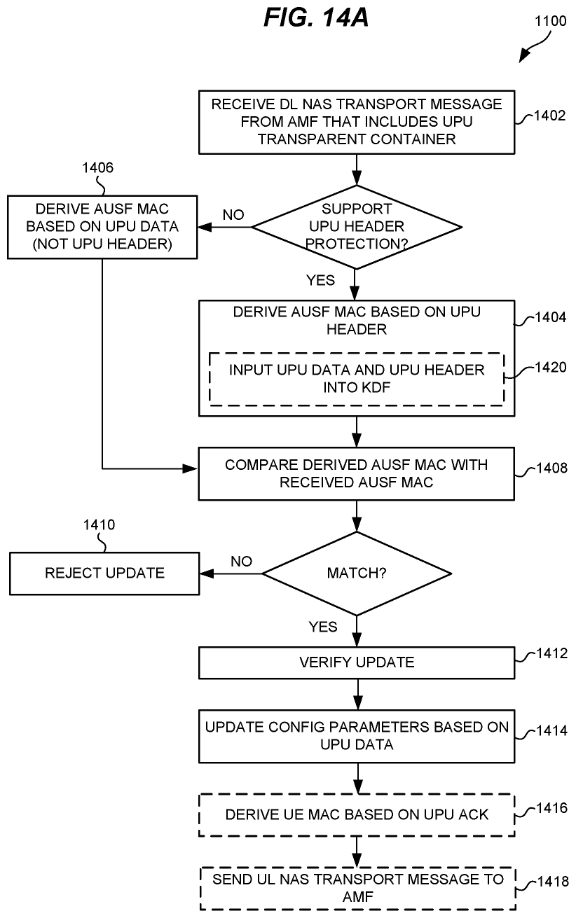

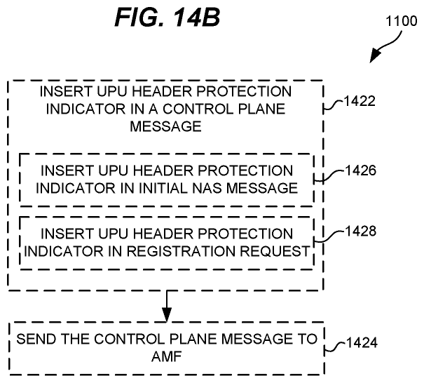

FIGS. 11-13 and 14A-14B are flow charts illustrating a method 1100 of performing the UE parameters update procedure in an illustrative embodiment. More particularly, the steps of method 1100 in FIG. 11 will be described with reference to UDM 218 in FIG. 6, the steps of method 1100 in FIG. 12 will be described with reference to AUSF 210 in FIG. 7, the steps of method 1100 in FIG. 13 will be described with reference to AMF 212 in FIG. 8, and the steps of method 1100 in FIG. 14A-14B will be described with reference to UE 106 in FIG. 9. Those skilled in the art will appreciate that method 1100 may be performed in other systems, devices, or network functions. The steps of the flow charts described herein are not all inclusive and may include other steps not shown, and the steps may be performed in an alternative order.

In FIG. 11, data management controller 604 of UDM 218 triggers a UE parameters update (UPU) for UE 106 (step 1102), such as for a RID update, a Network Slice Selection Assistance Information (NSSAI) update, etc. In other words, data management controller 604 decides to perform the UE parameters update using the control plane procedure while the UE 106 is registered to the 5G system 100. Upon triggering the UE parameters update, data management controller 604 invokes the UPU Protection service (e.g., Nausf_UPU Protection) towards AUSF 210, and generates a UPU protection request message (e.g., Nausf_UPUProtection Request message) requesting an AUSF MAC (i.e., UPU-MAC-I_{AUSF}) and a UPU counter (i.e., Counter_{UPU}) (step 1104). Data management controller 604 of UDM 218 is configured to include the SUPI for UE 106, UPU Information for the UE parameters update, and a UPU header protection indicator 1003 in the UPU protection request message.

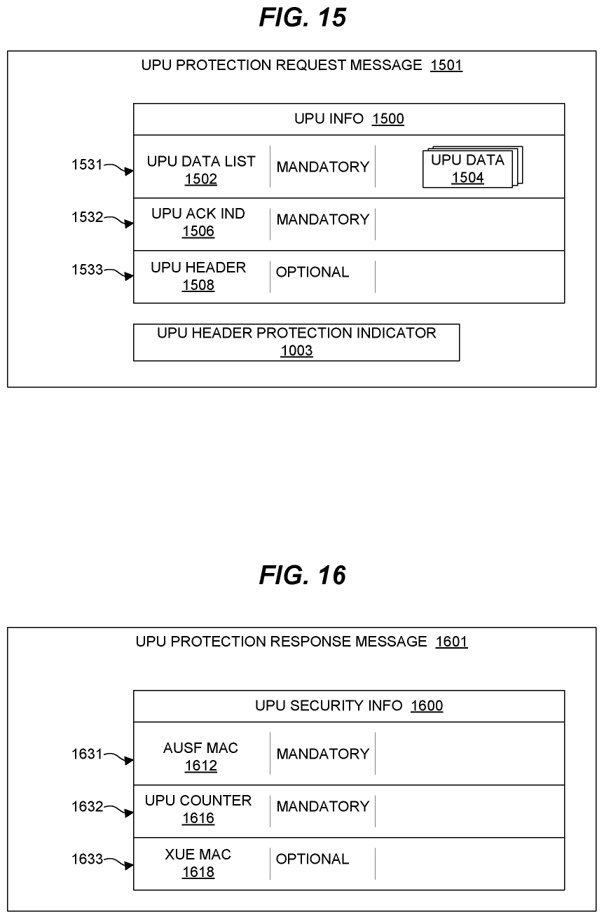

FIG. 15 is a block diagram illustrating a UPU protection request message 1501 for the UPU Protection service in an illustrative embodiment. The UPU protection request message 1501 includes UPU Information 1500 (also referred to as first UPU information) for the UPU Protection service. In FIG. 15, UPU Information 1500 contains the following attributes (also referred to as Information Elements (IE)): a UPU Data List attribute 1531, a UPU acknowledgement indicator attribute 1532, and a UPU Header attribute 1533. The UPU Data List attribute 1531 contains a UPU Data List 1502. The UPU Information 1500 may define updates to multiple UE parameters, and therefore, the UPU Data List 1502 may comprise a collection or array of UPU Data 1504. The UPU Data 1504 is information that defines the UE parameters update for a UE parameter. For example, the UPU Data 1504 may comprise routing indicator update data with a RID to be updated at the UE 106, default NSSAI update data with the default configured NSSAI to be updated at the UE 106, etc. Each data set of UPU Data 1504 comprises update data for an individual UE parameter. The UPU acknowledgement indicator attribute 1532 contains a UPU acknowledgement indicator 1506. The UPU acknowledgement indicator 1506 (e.g., a Boolean value) indicates whether the UE 106 is to respond to UDM 218 with a UE MAC (e.g., UPU-MAC-I_{UE}). The UPU Header attribute 1533 is optional, and may contain a UPU Header 1508. The UPU Header 1508 comprises information (separate or different from the UPU Data 1504) regarding the UE parameters update. For example, the UPU Header 1508 may comprise a UPU data type indicator (e.g., a value of “0” when the UE parameters update transparent container carries a UPU Data List, and a value of “1” when the UE parameters update transparent container carries an acknowledgement of successful reception of a UPU Data List), a UPU acknowledgement (ACK) indicator (e.g., a value of “0” when acknowledgement is not requested, and a value of “1” when acknowledgement is requested), a Re-registration (REG) indicator (e.g., a value of “0” when re-registration is not requested, and a value of “1” when re-registration is requested), etc.

The UPU Information 1500 may have a structured data type as provided for the Nausf_UPU Protection Service Application Programming Interface (API), as described in section 6.3 of 3GPP TS 29.509. The Nausf_UPU Protection Service API defines a “UpuInfo” data type as in section 6.3.6.2.2 of 3GPP TS 29.509. The “UpuInfo” data type includes the following attributes: “upuDataList”, “upuHeader”, “upuAckInd”, “supportedFeatures”, and “upuTransparentInfo”. In the “UpuInfo” data type, the “upuHeader” attribute is optional (i.e., “O”). The “upuHeader” attribute contains the “UPU Header” IE as specified in section 9.11.3.53A of 3GPP TS 24.501 (v.18.1.0), which is incorporated by reference as if fully included herein.

The UPU protection request message 1501 further includes a UPU header protection indicator 1003, which is a value, flag, or type of indicator that indicates whether a UE supports UPU header protection. For example, UPU header protection indicator 1003 may comprise a Boolean value, such as “T” or “F”, “1” or “0”, etc. UPU header protection indicator 1003 may be an optional input to the UPU Protection service as described above.

In FIG. 11, when triggering the UE parameters update, data management controller 604 determines or identifies whether UE 106 supports UPU header protection in derivation of a MAC (step 1106). When determining that UE 106 supports UPU header protection, data management controller 604 of UDM 218 sets the UPU header protection indicator 1003 in the UPU protection request message 1501 (step 1108) to indicate that UE 106 supports UPU header protection (e.g., set to “true”). Setting the UPU header protection indicator 1003 in this manner requests that AUSF 210 derive the AUSF MAC based on the UPU Header 1508. When determining that UE 106 does not support UPU header protection, data management controller 604 of UDM 218 does not set the UPU header protection indicator 1003 in the UPU protection request message 1501 to indicate that UE 106 supports UPU header protection (step 1110). For example, data management controller 604 may set the UPU header protection indicator 1003 to “false” or omit the UPU header protection indicator 1003 from the UPU protection request message 1501. This requests that AUSF 210 derive the AUSF MAC based on the UPU Data 1504 and not the UPU Header 1508. Data management controller 604 then sends the UPU protection request message 1501 to AUSF 210 (step 1112). One technical benefit is UDM 218 is able to request that AUSF 210 derive the AUSF MAC based on the UPU Header 1508 or not based on the UPU Header 1508, depending on the UPU header protection indicator 1003.

For step 1106, data management controller 604 may determine whether UE 106 supports UPU header protection in a variety of ways. For example, data management controller 604 may query a Unified Data Repository (UDR), a Home Subscriber Server (HSS), or another network function to acquire subscription information or capabilities information regarding UE 106. In an embodiment, data management controller 604 may receive the UPU header protection indicator 1003 prior to initiating a UE parameters update, such as during primary authentication (and/or re-authentication) of UE 106 (optional step 1130). For example, UE 106 may transmit a Registration Request to the serving network (e.g., the AMF 212 of the serving network) during primary authentication (see also, N1 message 311 sent in FIG. 3). UE 106 includes a UPU header protection indicator 1003 in the Registration Request indicating whether UE 106 supports UPU header protection. AMF 212 then passes the UPU header protection indicator 1003 to UDM 218 in an authentication or registration message. As described in FIG. 3, SEAF 302 of the AMF 212 invokes the Nausf_UEAuthentication service by sending a Nausf_UEAuthentication_Authenticate Request message 312 to AUSF 210 to initiate an authentication. SEAF 302 may include the UPU header protection indicator 1003 in the Nausf_UEAuthentication_Authenticate Request message 312. AUSF 210, in turn, sends a Nudm_UEAuthentication_Get Request message 313 to UDM 218. AUSF 210 may include the UPU header protection indicator 1003 in the Nudm_UEAuthentication_Get Request message 313. Data management controller 604 of UDM 218 receives the UPU header protection indicator 1003, such as in the Nudm_UEAuthentication_Get Request message 313, and stores the UPU header protection indicator 1003. Thus, when triggering the UE parameters update, data management controller 604 may determine whether a UPU header protection indicator 1003 was received or is stored for UE 106. One technical benefit is the UDM 218 receives the capabilities of the UE 106, such as during primary authentication.

In FIG. 12, authentication controller 704 of AUSF 210 receives the UPU protection request message 1501 from UDM 218 (step 1202). Authentication controller 704 processes the UPU protection request message 1501, and determines whether the UE 106 supports UPU head protection based on the UPU header protection indicator 1003 (step 1204). For example, authentication controller 704 processes the UPU protection request message 1501 determine whether the UPU protection request message 1501 includes UPU header protection indicator 1003 set to “true” or some other value indicative of UE 106 support of UPU header protection. When the UE 106 supports UPU head protection, authentication controller 704 derives or generates an AUSF MAC based on the UPU Header 1508 (step 1206). When the UE 106 does not support UPU head protection, authentication controller 704 derives or generates an AUSF MAC based on the UPU Data 1504 and exclusive of (i.e., not taking into account) the UPU Header 1508 (step 1208). One technical benefit is the AUSF 210 is instructed whether or not to derive the AUSF MAC based on the UPU Header 1508 according to UPU header protection indicator 1003 provided by UDM 218. When the AUSF MAC is derived based on the UPU Header 1508, another technical benefit is the UPU Header 1508 is protected in the UE parameters update.

Authentication controller 704 of AUSF 210 may also derive or generate an expected UE MAC (e.g., UPU-MAC-I_{UE}) based on the UPU acknowledgement indicator 1506 (optional step 1210), as is further described in 3GPP TS 33.501 (Annex A.20). Authentication controller 704 then sends a UPU protection response message (e.g., Nausf_UPUProtection Response message) to UDM 218 (step 1212). Authentication controller 704 includes UPU Security Information in the UPU protection response message. The UPU Security Information includes the AUSF MAC generated by AUSF 210, the UPU counter, and may optionally include the expected UE MAC. FIG. 16 is a block diagram illustrating a UPU protection response message 1601 for the UPU Protection service in an illustrative embodiment. The UPU protection response message 1601 includes UPU Security Information 1600 for the UPU Protection service. The UPU Security Information 1600 contains the material generated for securing of the UE parameters update, and includes the following attributes: an AUSF MAC attribute 1631, a UPU counter attribute 1632, and an expected UE MAC attribute 1633. The AUSF MAC attribute 1631 contains the AUSF MAC 1612. The UPU counter attribute 1632 contains the UPU Counter 1616. The expected UE MAC attribute 1633 contains an expected UE MAC 1618 (XUE MAC) if UDM 218 requests acknowledgement from UE 106.

The UPU Security Information 1600 may have a structured data type as provided for the Nausf_UPU Protection Service API, as described in section 6.3 of 3GPP TS 29.509. The Nausf_UPU Protection Service API defines a “UpuSecurityInfo” data type as in section 6.3.6.2.3 of 3GPP TS 29.509. The “UpuSecurityInfo” data type includes the following attributes: “upuMacIausf”, “counterUpu”, and “upuXmacIue”.

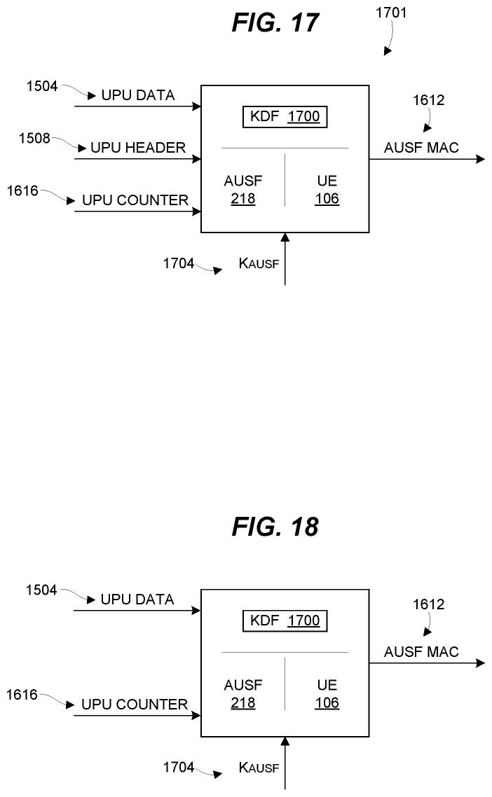

FIGS. 17-18 are a block diagrams illustrating derivation of an AUSF MAC in illustrative embodiments. An AUSF MAC 1612 is derived from a Key Derivation Function (KDF) 1700 using the K_{AUSF} key 1704 as an input key, as is further described in 3GPP TS 33.501 (Annex A.19). In an embodiment, the AUSF MAC generation function 1701 may be extended to include the UPU Header 1508 as shown in FIG. 17. For the AUSF MAC generation function 1701, the input parameters to the KDF 1700 are the UPU Data 1504 (i.e., the UPU Data List 1502), the UPU Header 1508, and the UPU Counter 1616. More particularly, the input parameters and their lengths are concatenated into a string S as: S=FC∥P0∥L0∥P1∥L1∥P2∥L2∥P3∥L3∥ . . . ∥Pn∥Ln. FC is used to distinguish between different instances of the algorithm. P0 . . . Pn are the n+1 input parameter encodings, and L0 . . . Ln are the two-octet representations of the length of the corresponding input parameter encodings P0 . . . Pn. When deriving the AUSF MAC 1612 based on the UPU Header 1508 in FIG. 17, the following input parameters may be used to form the string S that is input to KDF 1700:
FC =0x7B,
P0=UPU Data (i.e., UPU Data List),
L0=length of UPU Data,
P1=UPU Counter,
L1=length of UPU Counter,
P2=UPU Header (if UPU header protection indication set to true),
L2=length of UPU Header (if UPU header protection indication set to true).

The AUSF MAC 1612 (e.g., UPU-MAC-I_{AUSF}) may be identified with the 128 least significant bits of the output of the KDF 1700. Thus, for step 1206 in FIG. 12, authentication controller 704 of AUSF 210 may input the UPU Data 1504 and the UPU Header 1508 to KDF 1700 to derive the AUSF MAC 1612 (optional step 1214) as in FIG. 17. As will be further described below, update controller 936 of UE 106 may input the UPU Data 1504 and the UPU Header 1508 to KDF 1700 to derive the AUSF MAC (optional step 1420 of FIG. 14A) in a similar manner.

For step 1208 in FIG. 12, authentication controller 704 of AUSF 210 may input the UPU Data 1504 (without the UPU Header 1508) to KDF 1700 to derive the AUSF MAC 1612, as shown in FIG. 18. As will be further described below, update controller 936 of UE 106 may input the UPU Data 1504 (without the UPU Header 1508) to KDF 1700 to derive the AUSF MAC in a similar manner.

In FIG. 11, data management controller 604 of UDM 218 receives the UPU protection response message 1601 (e.g., Nausf_UPUProtection Response message) from AUSF 210 (step 1114) that includes the AUSF MAC 1612 (i.e., UPU-MAC-I_{AUSF}) and the UPU Counter 1616 (i.e., Counter_{UPU}). If the UPU acknowledgement indication 1506 was present in the UPU protection request message 1501, then the UPU protection response message 1601 further includes the expected UE MAC 1618 (e.g., UPU-XMAC-I_{UE}). Data management controller 604 may then temporarily store the expected UE MAC 1618 (optional step 1116).

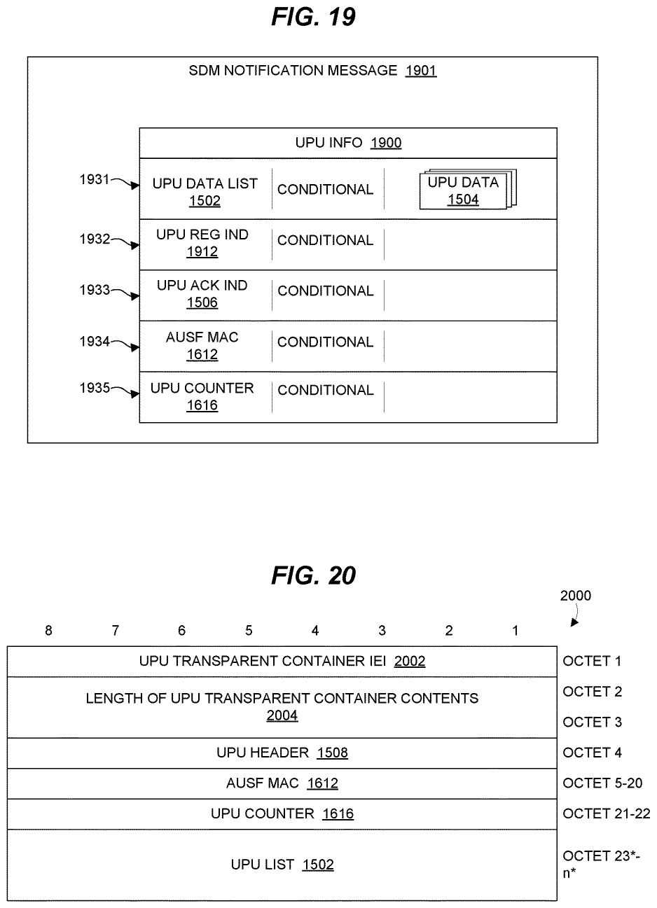

For the UPU procedure, data management controller 604 invokes a Subscriber Data Management (SDM) service of the UDM 218 (e.g., Nudm_SDM_Notification service), and generates an SDM notification message (e.g., Nudm_SDM_Notification message) (step 1118). Data management controller 604 includes UPU Information for the UE parameters update in the SDM notification message. The UPU Information (also referred to as second UPU Information) for the Subscriber Data Management service may be different than the UPU Information 1500 for the UPU Protection service. FIG. 19 is a block diagram illustrating an SDM notification message 1901 for the Subscriber Data Management service in an illustrative embodiment. The SDM notification message 1901 includes UPU Information 1900. UPU Information 1900 contains the following attributes (also referred to as IEs): a UPU Data List attribute 1931, a UPU re-registration indicator attribute 1932, a UPU acknowledgement indicator attribute 1933, a UPU AUSF MAC attribute 1934, and a UPU counter attribute 1935. The UPU Data List attribute 1931 contains a UPU Data List 1502 (i.e., the UPU Data 1504). The UPU Information 1900 may define updates to multiple UE parameters, and therefore, the UPU Data List 1502 may comprise a collection or array of UPU Data 1504. The UPU re-registration indicator attribute 1932 contains a UPU re-registration indicator 1912, which indicates whether re-registration of the UE 106 is requested. The UPU acknowledgement indicator attribute 1933 contains a UPU acknowledgement indicator 1506. The UPU AUSF MAC attribute 1934 contains the AUSF MAC 1612 derived by AUSF 210. The UPU counter attribute 1935 contains the UPU Counter 1616.

The UPU Information 1900 may have a structured data type as provided for the Nudm_SubscriberDataManagement Service API, as described in section 6.1 of 3GPP TS 29.503. The Nudm_SubscriberDataManagement Service API defines a “UpuInfo” data type as in 6.1.6.2.33 of 3GPP TS 29.503. The “UpuInfo” data type includes the following attributes: “upuDataList”, “upuRegInd”, “upuAckInd”, “upuMacIausf”, “counterUpu”, “provisioningTime”, and “upuTransparentContainer”.

In FIG. 11, data management controller 604 then sends the SDM notification message 1901 to AMF 212 (step 1120). In FIG. 13, access and mobility controller 804 of AMF 212 receives the SDM notification message 1901 from UDM 218 (step 1302). Access and mobility controller 804 formats or constructs a UPU transparent container based on the UPU Information 1900 in the SDM notification message 1901 (step 1304). Access and mobility controller 804 is configured to construct the UPU transparent container as described in section 9.11.3.53A of 3GPP TS 24.501. FIG. 20 is a block diagram illustrating a UPU transparent container 2000 in an illustrative embodiment. In a message from the network to the UE 106, UPU transparent container 2000 includes a UPU transparent container IE identifier (IEI) 2002, a container length 2004, the UPU Header 1508, the AUSF MAC 1612, the UPU Counter 1616, and the UPU Data List 1502. Access and mobility controller 804 populates the AUSF MAC 1612, the UPU Counter 1616, and the UPU Data List 1502 from the UPU Information 1900 in the SDM notification message 1901.

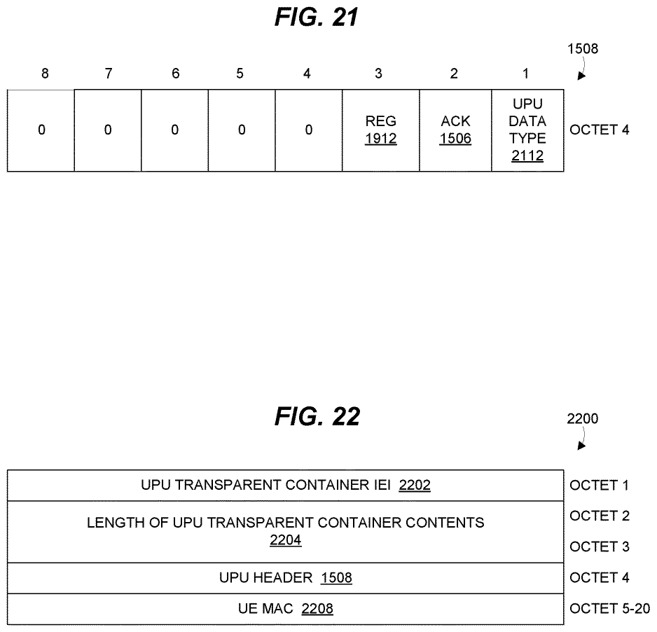

In constructing the UPU transparent container 2000, access and mobility controller 804 also generates the UPU Header 1508 of UPU transparent container 2000 from the UPU Information 1900 provided in the SDM notification message 1901. Although the SDM notification message 1901 does not pass a UPU Header 1508 as discussed above, access and mobility controller 804 is able to format the UPU Header 1508 of UPU transparent container 2000 using data passed in the SDM notification message 1901. FIG. 21 is a block diagram of a UPU Header 1508 of UPU transparent container 2000 in an illustrative embodiment. UPU Header 1508 includes a UPU re-registration (REG) indicator 1912, a UPU acknowledgement (ACK) indicator 1506, and a UPU data type 2112. Access and mobility controller 804 populates the UPU re-registration indicator 1912 and the UPU acknowledgement indicator 1506 from the UPU Information 1900 in the SDM notification message 1901. Access and mobility controller 804 sets the UPU data type 2112 based on whether the UPU transparent container 2000 is being sent from the network to the UE 106, or from the UE 106 to the network. For example, access and mobility controller 804 may set the UPU data type 2112 to a value of “0” when UPU transparent container 2000 carries a UPU Data List 1502 from the network to the UE 106, and to a value of “1” when UPU transparent container 2000 carries an acknowledgement of successful reception of a UPU Data List 1502 from the UE 106 to the network.

In FIG. 13, access and mobility controller 804 then sends a DL NAS Transport message to UE 106 with the UPU transparent container 2000 (step 1306), such as shown in FIG. 10A with DL NAS Transport message 1014. In FIG. 14A, ME 900 of UE 106 receives the DL NAS Transport message from AMF 212 that includes the UPU transparent container 2000 (step 1402). Upon receiving the DL NAS Transport message, update controller 936 of UE 106 derives or computes an AUSF MAC (e.g., UPU-MAC-I_{AUSF}) in the same way as AUSF 210. When UE 106 supports UPU header protection, update controller 936 derives or generates an AUSF MAC (also referred to as a derived AUSF MAC) based on the UPU Header 1508 (step 1404), such as shown in FIG. 17. When UE 106 does not support UPU header protection, update controller 936 derives or generates an AUSF MAC based on the UPU Data 1504 and exclusive of (i.e., not taking into account) the UPU Header 1508 (step 1406), such as shown in FIG. 18. One technical benefit is the UE 106 derives the AUSF MAC in the same manner as AUSF 210.

Update controller 936 then compares the derived AUSF MAC with the received AUSF MAC 1612 received in the UPU transparent container 2000 to determine whether they match (step 1408). When the derived AUSF MAC and the received AUSF MAC 1612 do not match, update controller 936 rejects the UE parameters update (step 1410). When the derived AUSF MAC and the received AUSF MAC 1612 match, update controller 936 verifies the UE parameters update (step 1412). When verification of the AUSF MAC 1612 is successful, update controller 936 updates one or more configuration parameters of ME 900 and/or USIM 960 based on the UPU Data 1504 (step 1414). If the UPU Data 1504 contains configuration parameters that are protected by secured packet, then ME 900 of UE 106 forwards the secured packet to USIM 960. When verification of the AUSF MAC 1612 is successful and the UPU Data 1504 contains configuration parameters that are not protected by secured packet, ME 900 of UE 106 updates its stored parameters with the received parameters in UPU Updata Data.

If UDM 218 has requested an acknowledgement from UE 106 and UE 106 has successfully verified and updated the UPU Data 1504 provided by UDM 218, then update controller 936 derives or generates a UE MAC (e.g., UPU-MAC-I_{UE}) based on the UPU acknowledgement indicator 1506 (optional step 1416) in the same manner that AUSF 210 derived the expected UE MAC 1618. UE 106 then sends a UL NAS Transport message to AMF 212 (optional step 1418), such as for UL NAS Transport message 1016 as shown in FIG. 10A. UE 106 includes the UE MAC in a transparent container in the UL NAS Transport message. FIG. 22 is a block diagram illustrating a UPU transparent container 2200 in an illustrative embodiment. In a message from UE 106 to the network, UPU transparent container 2200 includes an UPU transparent container IEI 2202, a container length 2204, the UPU Header 1508, and the UE MAC 2208 generated by UE 106.

In FIG. 13, access and mobility controller 804 of AMF 212 receives the UL NAS Transport message from UE 106 (optional step 1308). Access and mobility controller 804 invokes a Subscriber Data Management service of the UDM 218 (i.e., Nudm_SDM_Info service) to provide acknowledgement from the UE 106 to UDM 218 about successful delivery of UPU Data 1504. Access and mobility controller 804 sends an SDM information message (e.g., Nudm_SDM_Info message 1014 as in FIG. 10A) with the UE MAC 2208 to UDM 218 (optional step 1310).

In FIG. 11, data management controller 604 of UDM 218 receives the SDM information message from AMF 212 (optional step 1122). If UDM 218 indicated that UE 106 is to acknowledge the successful security check of the received UPU Data 1504, then UDM 218 compares the received UE MAC 2208 derived by the UE 106 with the expected UE MAC 1618 that UDM 218 stores temporarily. If the received UE MAC 2208 and the expected UE MAC 1618 match, then data management controller 604 verifies success of the UE parameters update (optional step 1124).

As described above, UE 106 may provide a UPU header protection indicator 1003 to the network indicating whether UE 106 supports UPU header protection prior to the network initiating a UE parameters update. FIG. 14B is a flow chart illustrating additional details of method 1100 in an illustrative embodiment. As described above, a UE 106 supports UPU header protection when the UE 106 is configured to derive a AUSF MAC 1612 (e.g., UPU-MAC-I_{AUSF}) based at least in part on a UPU Header 1508. For example, the UE 106 may be configured to derive the AUSF MAC 1612 as illustrated in FIG. 17. In an embodiment, update controller 936 of UE 106 signals to the network that it supports UPU header protection with a UPU header protection indicator 1003. Thus, update controller 936 inserts the UPU header protection indicator 1003 in a control plane message directed to the 5GC 104 (optional step 1422). Update controller 936 then sends the control plane message to AMF 212 (optional step 1424). In an embodiment, UE 106 may insert the UPU header protection indicator 1003 in an initial NAS message (optional step 1426) to the serving network (e.g., the AMF 212 of the serving network), such as an N1 message 311 as shown in FIG. 3. One example of an N1 message 311 is a Registration Request provided during primary authentication of UE 106, and UE 106 may insert the UPU header protection indicator 1003 in a Registration Request (optional step 1428). One technical benefit is UE 106 is able to signal to the network that it supports UPU header protection, such as during primary authentication. However, UE 106 may signal to the network that it supports UPU header protection in other ways.

One technical benefit of the UE parameters update procedure as described above for method 1100 is the present data structures defined by the 3GPP may be used for the UE parameters update procedure, but the usage of the UPU Header 1508 is defined. UDM 218 is able to request that AUSF 210 derive an AUSF MAC based on the UPU Header 1508 using a UPU header protection indicator 1003 in a UPU Protection request message. Thus, when a UE 106 is configured to support UPU header protection, AUSF 210 derives an AUSF MAC based on the UPU Header 1508, and UE 106 performs a similar derivation. When a UE 106 does not support UPU header protection, AUSF 210 derives an AUSF MAC based on UPU Data 1504 and not the UPU Header 1508, and UE 106 performs a similar derivation. Thus, even though the UPU Header 1508 is optional, AUSF 210 and UE 106 will derive the AUSF MAC in similar manner so that the UE parameters update can be verified.

### Embodiment 2

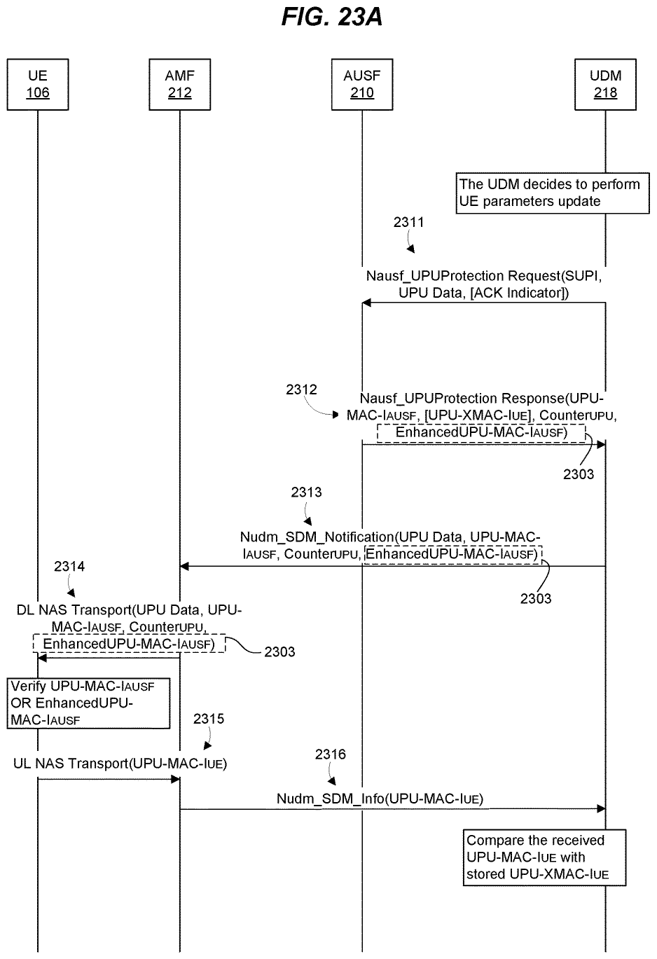

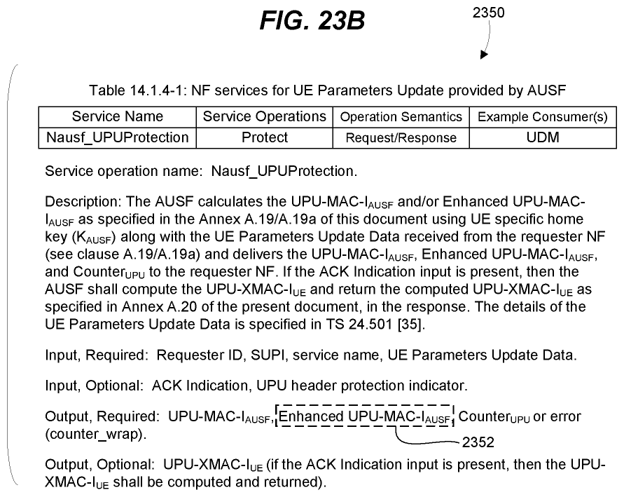

FIG. 23A is a message diagram illustrating a UE parameters update procedure in an illustrative embodiment. The UE parameters update procedure described in FIG. 23A may be an extension to section 6.15.2.1 of 3GPP TS 33.501. As a general overview, an AUSF 210 may additionally derive an enhanced AUSF MAC (i.e., Enhanced UPU-MAC-I_{AUSF}) based on the UPU Header. In this embodiment, an AUSF MAC derived exclusive of a UPU Header is referred to as a conventional AUSF MAC (i.e., UPU-MAC-I_{AUSF}), and an AUSF MAC derived based on a UPU Header is referred to as an enhanced AUSF MAC. The conventional AUSF MAC and the enhanced AUSF MAC may then be passed to the UE 106 along with the UPU Data. If the UE 106 does not support UPU header protection, then the UE 106 may derive a conventional AUSF MAC exclusive of the UPU Header for verification. If the UE 106 supports UPU header protection, then the UE 106 may derive an enhanced AUSF MAC based on the UPU Header for verification. One technical benefit is the UPU Header may be protected in the UE parameters update, along with any other UPU Information (e.g., UPU Data) used to derive the enhanced AUSF MAC. If the UE 106 does not support UPU header protection, then the UE 106 may derive a conventional AUSF MAC for verification. Thus, existing UEs can still perform a UE parameters update based on the UPU Data without breaking the backward compatibility so that an existing UE and a new UE both can work when the feature is deployed.

In an embodiment, UDM 218 decides to perform the UE parameters update (UPU) using the control plane procedure while the UE 106 is registered to the 5G system 100. If the final consumer of any of the UE parameters to be updated (e.g., updated RID) is the USIM of a UE 106, UDM 218 protects these parameters using a secured packet mechanism to update the parameters stored on the USIM. UDM 218 prepares the UPU Data by including the parameters protected by the secured packet, if any, as well as any UE parameters for which the final consumer is the ME of the UE 106.

UDM 218 invokes the Nausf_UPUProtection service by sending a Nausf_UPUProtection Request message 2311 to AUSF 210 to get the UPU-MAC-I_{AUSF} and Counter_{UPU}. UDM 218 includes the SUPI, UPU Data, and UPU header in the Nausf_UPUProtection Request message 2311. If UDM 218 decided that the UE 106 is to acknowledge the successful security check of the received UPU Data, then UDM 218 sets the corresponding indication in the UPU Data and includes an ACK Indication in the Nausf_UPUProtection Request message 2311 to signal that it also needs the expected UPU-XMAC-I_{UE}.

AUSF 210 computes or derives the UPU-MAC-I_{AUSF} using UE specific home key (K_{AUSF}), and delivers the UPU-MAC-I_{AUSF} and the Counter_{UPU} to UDM 218 in a Nausf_UPUProtection Response message 2312. The inclusion of the UPU Data in the calculation of UPU-MAC-I_{AUSF} allows the UE 106 to verify that the UPU Data has not been tampered by any intermediary. In an embodiment, AUSF 210 also computes or derives an Enhanced UPU-MAC-I_{AUSF} 2303 based, at least in part, on the UPU Header, and returns the Enhanced UPU-MAC-I_{AUSF} 2303 in the Nausf_UPUProtection Response message 2312. The inclusion of the UPU Header in the calculation of the Enhanced UPU-MAC-I_{AUSF} 2303 allows the UE 106 to verify that the UPU Header has not been tampered by any intermediary. If the ACK Indication is present in the Nausf_UPUProtection Request message 2311, then AUSF 210 computes or derives the UPU-XMAC-I_{UE} and returns the computed UPU-XMAC-I_{UE} in the Nausf_UPUProtection Response message 2312. The expected UPU-XMAC-I_{UE} allows UDM 218 to verify that the UE 106 received the UPU Data correctly.

UDM 218 then invokes the Nudm_SDM_Notification service operation, and transmits an Nudm_SDM_Notification message 2313 to AMF 212 which includes the UPU transparent container if AMF 212 supports UPU transparent containers, or includes individual Information Elements (IEs) comprising the UPU Data, the UPU-MAC-I_{AUSF}, the Enhanced UPU-MAC-I_{AUSF} 2303, and the Counter_{UPU}. If UDM 218 requests an acknowledgement, it temporarily stores the expected UPU-XMAC-I_{UE}. Upon receiving the Nudm_SDM_Notification message 2313, AMF 212 sends a DL NAS Transport message 2314 to UE 106. AMF 212 includes the transparent container in the DL NAS Transport message 1014 if received from UDM 218. Otherwise, if UDM 218 provided individual IEs, then AMF 212 constructs a UPU container.

If UE 106 does not support UPU header protection and on receiving the DL NAS Transport message 2314, UE 106 calculates the UPU-MAC-I_{AUSF} in the same way as AUSF 210 based on the received UPU Data and the Counter_{UPU}, and verifies whether it matches the UPU-MAC-I_{AUSF} value received in the DL NAS Transport message 2314. If UE 106 supports UPU header protection and on receiving the DL NAS Transport message 2314, UE 106 calculates the Enhanced UPU-MAC-I_{AUSF} in the same way as AUSF 210 based on the received UPU Data, the Counter_{UPU}, and the UPU Header, and verifies whether it matches the Enhanced UPU-MAC-I_{AUSF} value received in the DL NAS Transport message 2314. If the verification of UPU-MAC-I_{AUSF} or the Enhanced UPU-MAC-I_{AUSF} is successful and the UPU Data contains any parameters that are protected by secured packet, then the ME of UE 106 forwards the secured packet to the USIM. If the verification of UPU-MAC-I_{AUSF} or the Enhanced UPU-MAC-I_{AUSF} is successful and the UPU Data contains any parameters that are not protected by secured packet, then the ME of UE 106 updates its stored parameters with the received parameters in UDM Updata Data.

If UDM 218 has requested an acknowledgement from UE 106 and UE 106 has successfully verified and updated the UPU Data provided by UDM 218, then UE 106 sends a UL NAS Transport message 2315 to the serving AMF 212. UE 106 generates the UPU-MAC-I_{UE}, and includes the generated UPU-MAC-I_{UE} in a transparent container in the UL NAS Transport message 2315. AMF 212 sends a Nudm_SDM_Info message 2316 with the UPU-MAC-I_{UE} to UDM 218. If a transparent container with the UPU-MAC-I_{UE} was received in the UL NAS Transport message 2315, then AMF 212 sends the Nudm_SDM_Info message 2316 with the transparent container to the UDM 218. If UDM 218 indicated that UE 106 is to acknowledge the successful security check of the received UPU Data, then UDM 218 compares the received UPU-MAC-I_{UE} with the expected UPU-XMAC-I_{UE} that UDM 218 stored temporarily to verify that UE 106 successfully received the UPU data.

To provide the Enhanced UPU-MAC-I_{AUSF} 2303 from AUSF 210 to UDM 218, the UPU Protection service (e.g., Nausf_UPUProtection service) may be extended. FIG. 23B illustrates an extension 2350 to the Nausf_UPUProtection service to include an Enhanced UPU-MAC-I_{AUSF} 2303 in an illustrative embodiment. As described in section 14.1.4 of 3GPP TS 33.501, the Nausf_UPUProtection service specifies the following as required output: UPU-MAC-I_{AUSF}, and Counter_{UPU} or error. In an embodiment, the extension 2350 to the Nausf_UPUProtection service provides for the Enhanced UPU-MAC-I_{AUSF} 2303 as a required output 2352. One technical benefit is the AUSF 210 is able to report the Enhanced UPU-MAC-I_{AUSF} 2303 to UDM 218.

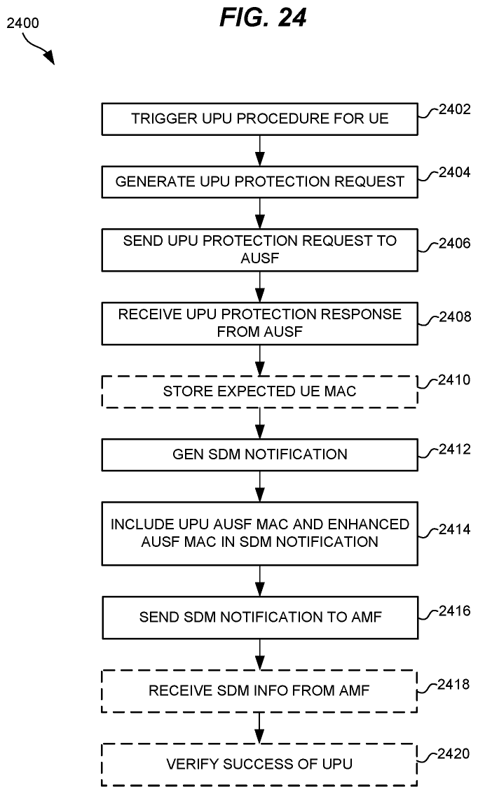

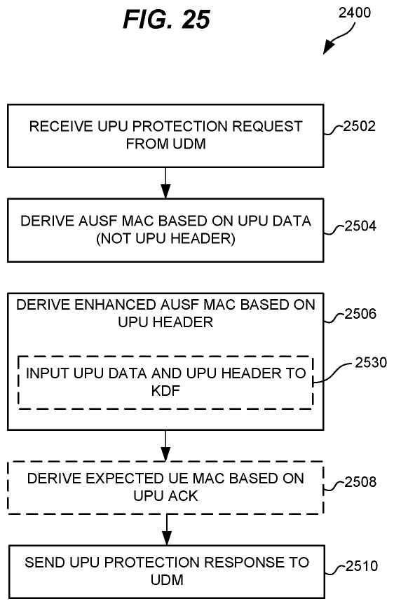

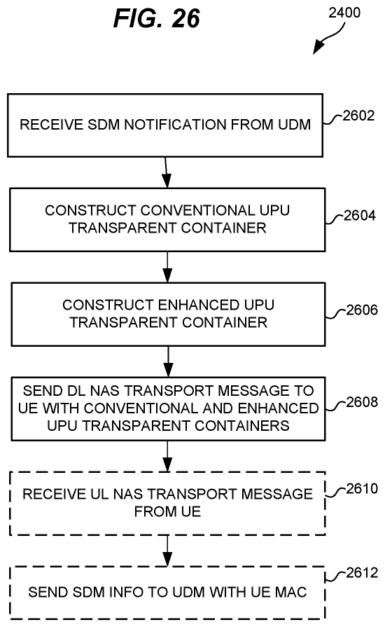

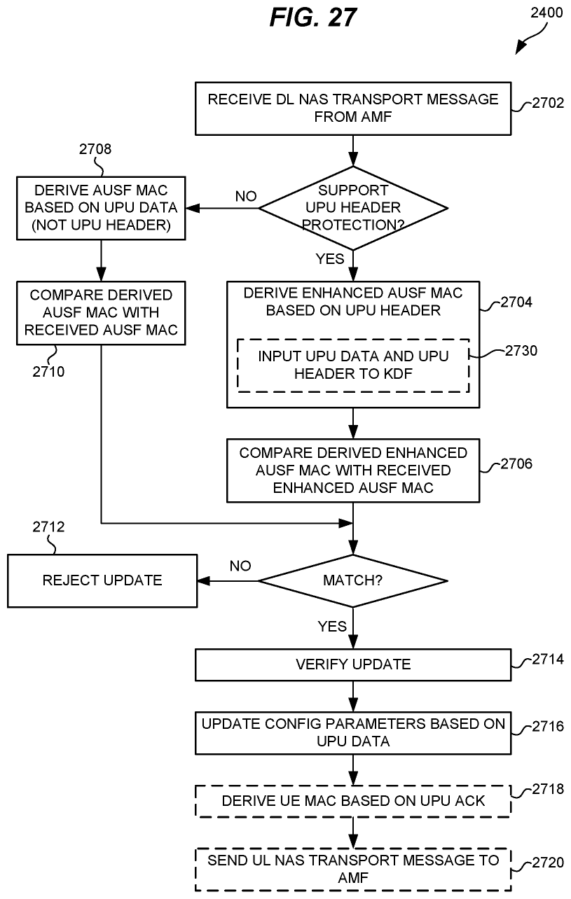

FIGS. 24-27 are flow charts illustrating a method 2400 of performing the UE parameters update procedure in an illustrative embodiment. More particularly, the steps of method 2400 in FIG. 24 will be described with reference to UDM 218 in FIG. 6, the steps of method 2400 in FIG. 25 will be described with reference to AUSF 210 in FIG. 7, the steps of method 2400 in FIG. 26 will be described with reference to AMF 212 in FIG. 8, and the steps of method 2400 in FIG. 27 will be described with reference to UE 106 in FIG. 9. Those skilled in the art will appreciate that method 2400 may be performed in other systems, devices, or network functions.

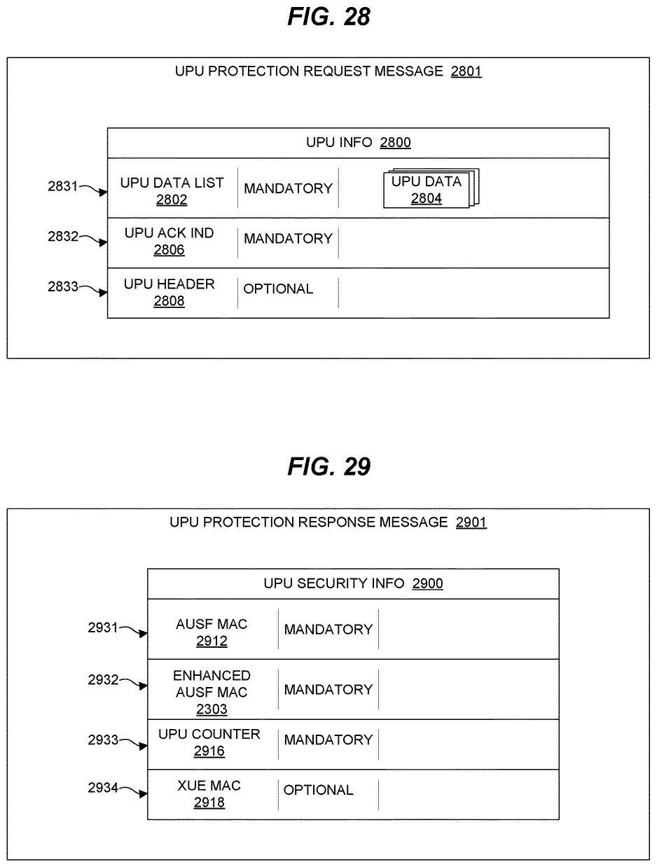

In FIG. 24, data management controller 604 of UDM 218 triggers a UE parameters update (UPU) procedure for UE 106 (step 2402), such as for a RID update, an NSSAI update, etc. In other words, data management controller 604 decides to perform the UE parameters update using the control plane procedure while the UE 106 is registered to the 5G system 100. Upon triggering the UE parameters update procedure, data management controller 604 invokes the UPU Protection service (e.g., Nausf_UPU Protection) towards AUSF 210, and generates a UPU protection request message (e.g., Nausf_UPUProtection Request message) (step 2404). Data management controller 604 of UDM 218 is configured to include the SUPI for UE 106, and UPU Information (also referred to as first UPU information) for the UE parameters update in the UPU protection request message (e.g., UPU Data and UPU Header). FIG. 28 is a block diagram illustrating a UPU protection request message 2801 for the UPU Protection service in an illustrative embodiment. The UPU protection request message 2801 includes UPU Information 2800 (also referred to as first UPU information) for the UPU Protection service. In FIG. 28, UPU Information 2800 includes the following attributes (also referred to as Information Elements (IE)): a UPU Data List attribute 2831, a UPU acknowledgement indicator attribute 2832, and a UPU Header attribute 2833. The UPU Data List attribute 2831 contains the UPU Data List 2802 (i.e., the UPU Data 2804). The UPU acknowledgement indicator attribute 2832 contains the UPU acknowledgement indicator 2806. The UPU Header attribute 2833 contains the UPU Header 2808. In FIG. 24, data management controller 604 sends the UPU protection request message 2801 to AUSF 210 (step 2406).

In FIG. 25, authentication controller 704 of AUSF 210 receives the UPU protection request message 2801 from UDM 218 (step 2502). Authentication controller 704 derives or generates a conventional AUSF MAC (also referred to as a first MAC) based on the UPU Data 2804 and exclusive of the UPU Header 2808 (step 2504). In an embodiment, authentication controller 704 also derives or generates an enhanced AUSF MAC 2303 (also referred to as a second MAC) based on the UPU Header 2808 (step 2506). For example, authentication controller 704 may decide based on an operator policy to derive the enhanced AUSF MAC 2303 along with the conventional AUSF MAC. In another example, authentication controller 704 may receive some type of indicator or instruction from UDM 218 when to derive the enhanced AUSF MAC 2303. Authentication controller 704 may also derive or generate an expected UE MAC (e.g., UPU-MAC-I_{UE}) based on the UPU acknowledgement indicator 2806 (optional step 2508).

Authentication controller 704 then sends a UPU protection response message (e.g., Nausf_UPUProtection Response message) to UDM 218 (step 2510). Authentication controller 704 includes UPU Security Information in the UPU protection response message. The UPU Security Information includes the conventional AUSF MAC and the enhanced AUSF MAC 2303 generated by AUSF 210, the UPU counter, and may optionally include the expected UE MAC. FIG. 29 is a block diagram illustrating a UPU protection response message 2901 for the UPU Protection service in an illustrative embodiment. The UPU protection response message 2901 includes UPU Security Information 2900 for the UPU Protection service. The UPU Security Information 2900 contains the material generated for securing of the UE parameters update, and includes the following attributes: an AUSF MAC attribute 2931, an enhanced AUSF MAC attribute 2932, a UPU counter attribute 2933, and an expected UE MAC attribute 2934. The AUSF MAC attribute 2931 contains the conventional AUSF MAC 2912. The enhanced AUSF MAC attribute 2932 contains the enhanced AUSF MAC 2303. The UPU counter attribute 2933 contains the UPU Counter 2916. The expected UE MAC attribute 2934 contains an expected UE MAC 2918 (XUE MAC) if UDM 218 requests acknowledgement from UE 106. One technical benefit of deriving both MACs is a UE 106 that supports UPU header protection or a UE 106 that does not support UPU header protection are able to verify a UE parameters update.

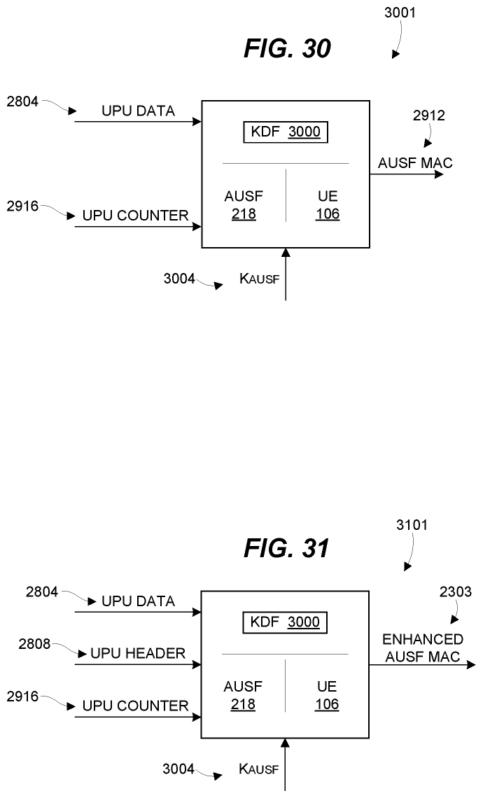

In step 2504 of FIG. 25, authentication controller 704 derives the conventional AUSF MAC 2912 based on the UPU Data 2804 and exclusive of the UPU Header 2808. FIG. 30 is a block diagram illustrating derivation of a conventional AUSF MAC 2912 in an illustrative embodiment. In an AUSF MAC generation function 3001, a conventional AUSF MAC 2912 is derived from a KDF 3000 using the K_{AUSF} key 3004 as an input key. When deriving the conventional AUSF MAC 2912 based on the UPU Data 2804 in FIG. 30, the following input parameters may be used to form the string S that is input to KDF 3000:
FC=0x7B,
P0=UPU Data,
L0=length of UPU Data,
P1=UPU Counter,
L1=length of UPU Counter.

In step 2506 in FIG. 25, authentication controller 704 derives the enhanced AUSF MAC 2303 based on the UPU Header 2808. FIG. 31 is a block diagram illustrating derivation of an enhanced AUSF MAC 2303 in an illustrative embodiment. In an embodiment, an enhanced AUSF MAC generation function 3101 is described that includes the UPU Header 2808. The enhanced AUSF MAC generation function 3101 may be an extension to 3GPP TS 33.501 (e.g., Annex A.19a). When deriving the enhanced AUSF MAC 2303 based on the UPU Header 2808 in FIG. 31, the following input parameters may be used to form the string S that is input to KDF 3000:
FC=0x7B,
P0=UPU Data (i.e., UPU Data List),
L0=length of UPU Data,
P1=UPU Counter,
L1=length of UPU Counter,
P2=UPU Header,
L2=length of UPU header.

The enhanced AUSF MAC 2303 (e.g., Enhanced UPU-MAC-I_{AUSF}) may be identified with the 128 least significant bits of the output of the KDF 3000.

For step 2506 in FIG. 25, authentication controller 704 of AUSF 210 may input the UPU Data 2804 and the UPU Header 2808 (along with the UPU Counter 2916) as input parameters to KDF 3000 to derive the enhanced AUSF MAC 2303 (optional step 2530). As will be further described below, update controller 936 of UE 106 may input the UPU Data 2804 and the UPU Header 2808 as input parameters to KDF 3000 to derive an enhanced AUSF MAC (optional step 2730 of FIG. 27) in a similar manner.

In FIG. 24, data management controller 604 of UDM 218 receives the UPU protection response message 2901 (e.g., Nausf_UPUProtection Response message) from AUSF 210 (step 2408) that includes the conventional AUSF MAC 2912, the enhanced AUSF MAC 2303, and the UPU Counter 2916. If the UPU acknowledgement indication 2806 was present in the UPU protection request message 2801, then the UPU protection response message 2901 further includes the expected UE MAC 2918. Data management controller 604 may then temporarily store the expected UE MAC 2918 (optional step 2410).

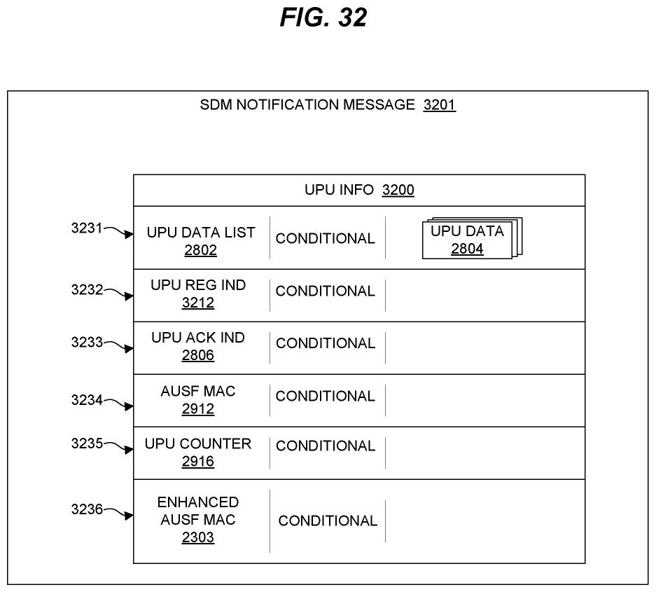

For the UPU procedure, data management controller 604 invokes a Subscriber Data Management (SDM) service of the UDM 218 (e.g., Nudm_SDM_Notification service), and generates an SDM notification message (e.g., Nudm_SDM_Notification message) (step 2412). Data management controller 604 of UDM 218 is configured to include UPU Information (also referred to as second UPU information) for the UE parameters update in the SDM notification message. In an embodiment, the UPU Information is enhanced in the Subscriber Data Management service with enhanced UPU information. FIG. 32 is a block diagram illustrating an SDM notification message 3201 for the Subscriber Data Management service in an illustrative embodiment. The SDM notification message 3201 includes UPU Information 3200. The UPU Information 3200 includes the following attributes: a UPU Data List attribute 3231, a UPU re-registration indicator attribute 3232, a UPU acknowledgement indicator attribute 3233, an AUSF MAC attribute 3234, a UPU counter attribute 3235, and an enhanced UPU information attribute 3236. The UPU Data List attribute 3231 contains a UPU Data List 2802 (i.e., the UPU Data 2804). The UPU re-registration indicator attribute 3232 contains the UPU re-registration indicator 3212, which indicates whether re-registration of the UE 106 is requested. The UPU acknowledgement indicator attribute 3233 contains the UPU acknowledgement indicator 2806. The AUSF MAC attribute 3234 contains the conventional AUSF MAC 2912 derived by AUSF 210. The UPU counter attribute 3235 contains the UPU Counter 2916. The enhanced UPU information attribute 3236 contains the enhanced AUSF MAC 2303 derived by AUSF 210.

In FIG. 24, data management controller 604 of UDM 218 includes the conventional AUSF MAC 2912 and the enhanced AUSF MAC 2303 in the SDM notification message 3201 (step 2414). Data management controller 604 then sends the SDM notification message 3201 to AMF 212 (step 2416).

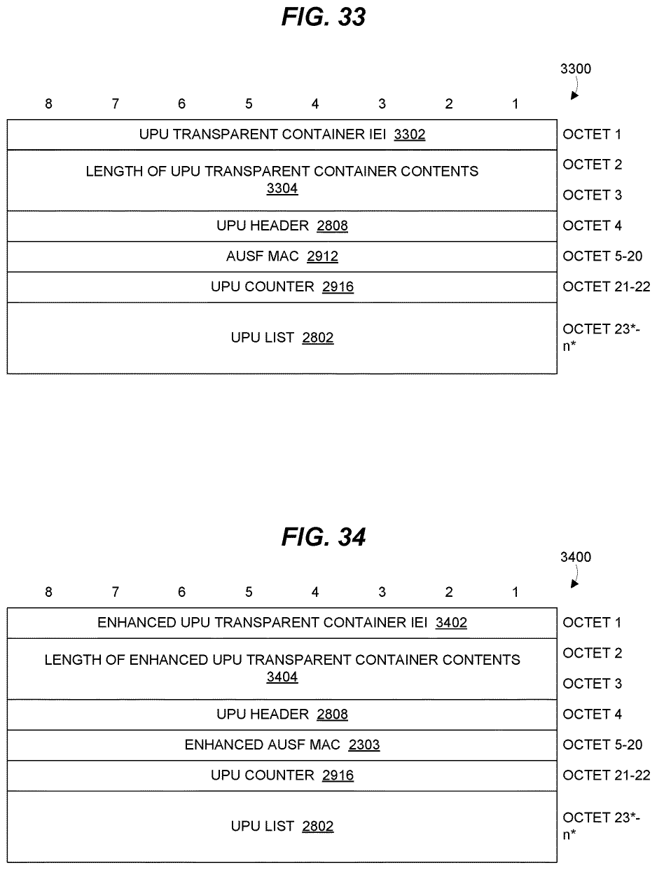

In FIG. 26, access and mobility controller 804 of AMF 212 receives the SDM notification message 3201 (e.g., Nudm_SDM_Notification message) from UDM 218 (step 2602). In response to the SDM notification message, access and mobility controller 804 formats or constructs a conventional UPU transparent container (also referred to as a first UPU transparent container) based on the UPU Information 3200 (step 2604), which includes at least the UPU Data 2804, the UPU Header 2808, and the conventional AUSF MAC 2912. A “conventional” UPU transparent container is constructed as described in section 9.11.3.53A of 3GPP TS 24.501. FIG. 33 is a block diagram illustrating a conventional UPU transparent container 3300 in an illustrative embodiment. In a message from the network to the UE 106, a conventional UPU transparent container 3300 includes a UPU transparent container IEI 3302, a container length 3304, the UPU Header 2808, the conventional AUSF MAC 2912, the UPU Counter 2916, and the UPU Data List 2802. Access and mobility controller 804 populates the conventional AUSF MAC 2912, UPU Counter 2916, and UPU Data List 2802 from the UPU Information 3200 in the SDM notification message 3201.

In FIG. 26, access and mobility controller 804 formats or constructs an enhanced UPU transparent container (also referred to as a second UPU transparent container) based on the UPU Information 3200 (step 2606), which includes at least the enhanced AUSF MAC 2303. FIG. 34 is a block diagram illustrating an enhanced UPU transparent container 3400 in an illustrative embodiment. In an embodiment, enhanced UPU transparent container 3400 may have the same format as the conventional UPU transparent container 3300 as in FIG. 33. In a message from the network to the UE 106, enhanced UPU transparent container 3400 includes an enhanced UPU transparent container IEI 3402, a container length 3404, the UPU Header 2808, the enhanced AUSF MAC 2303, the UPU Counter 2916, and the UPU Data List 2802. In FIG. 26, access and mobility controller 804 sends a DL NAS Transport message to UE 106 with the conventional UPU transparent container 3300 and the enhanced UPU transparent container 3400 (step 2608).

In FIG. 27, ME 900 of UE 106 receives the DL NAS Transport message from AMF 212 (step 2702). Upon receiving the DL NAS Transport message, update controller 936 derives or computes an AUSF MAC or enhanced AUSF MAC in the same way as AUSF 210. When the UE 106 supports UPU header protection, update controller 936 derives or computes an enhanced AUSF MAC (also referred to as a derived enhanced AUSF MAC or a third MAC) based on the UPU Header 2808 (step 2704). For example, update controller 936 may input the UPU Data 2804 and the UPU Header 2808 as input parameters into KDF 3000 to generate the enhanced AUSF MAC (optional step 2730), such as shown in FIG. 31. Update controller 936 then compares the derived enhanced AUSF MAC with the received enhanced AUSF MAC 2303 received in the enhanced UPU transparent container 3400 (step 2706).

When the UE 106 does not support UPU header protection, update controller 936 derives or generates a conventional AUSF MAC (also referred to as a derived conventional AUSF MAC or fourth MAC) based on the UPU Data 2804 and exclusive of (i.e., not taking into account) the UPU Header 2808 (step 2708). For example, update controller 936 may derive or generate the conventional AUSF MAC based on the UPU Data 2804 exclusive of the UPU Header 2808, such as shown in FIG. 30. Update controller 936 then compares the derived conventional AUSF MAC with the received conventional AUSF MAC 2912 received in the conventional UPU transparent container 3300 to determine whether they match (step 2710).

When the derived MAC and the received MAC do not match, update controller 936 rejects the UE parameters update (step 2712). When the derived MAC and the received MAC match, update controller 936 verifies the UE parameters update (step 2714). When verification is successful, update controller 936 updates one or more configuration parameters of ME 900 and/or USIM 960 based on the UPU Data 2804 (step 2716), such as provided in the conventional UPU transparent container 3300. If the UPU Data 2804 contains configuration parameters that are protected by secured packet, then ME 900 of UE 106 forwards the secured packet to USIM 960. When verification is successful and the UPU Data 2804 contains configuration parameters that are not protected by secured packet, ME 900 of UE 106 updates its stored parameters with the received parameters in UPU Updata Data.

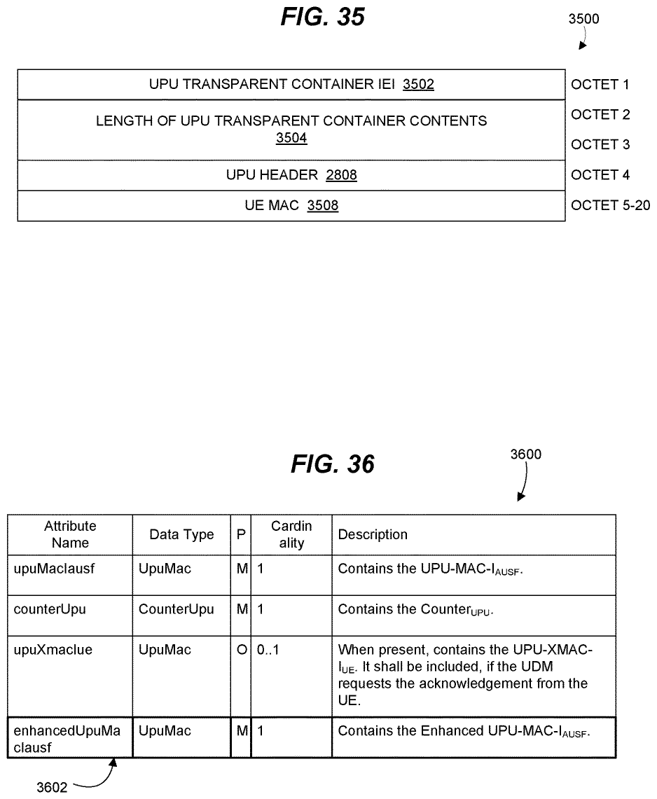

If UDM 218 has requested an acknowledgement from UE 106 and UE 106 has successfully verified and updated the UPU Data 2804 provided by UDM 218, then update controller 936 derives or generates a UE MAC (e.g., UPU-MAC-I_{UE}) based on the UPU acknowledgement indicator 2806 (optional step 2718) in the same manner that AUSF 210 derived the expected UE MAC 2918. UE 106 then sends a UL NAS Transport message to AMF 212 (optional step 2720). UE 106 includes the UE MAC in a transparent container in the UL NAS Transport message. FIG. 35 is a block diagram illustrating a UPU transparent container 3500 in an illustrative embodiment. In a message from UE 106 to the network, UPU transparent container 3500 includes a UPU transparent container IEI 3502, a container length 3504, the UPU Header 2808, and the UE MAC 3508 generated by UE 106.

In FIG. 26, access and mobility controller 804 of AMF 212 receives the UL NAS Transport message from UE 106 (optional step 2610). Access and mobility controller 804 invokes a Subscriber Data Management service of the UDM 218 (e.g., Nudm_SDM_Info service) to provide acknowledgement from the UE 106 to UDM 218 about successful delivery of UPU Data 2804. Access and mobility controller 804 sends an SDM information message (e.g., Nudm_SDM_Info message) with the UE MAC 3508 to UDM 218 (optional step 2612).

In FIG. 24, data management controller 604 of UDM 218 receives the SDM information message from AMF 212 (optional step 2418). If UDM 218 indicated that UE 106 is to acknowledge the successful security check of the received UPU Data 2804, then UDM 218 compares the received UE MAC 3508 derived by the UE 106 with the expected UE MAC 2918 that UDM 218 stores temporarily. If the received UE MAC 3508 and the expected UE MAC 2918 match, then data management controller 604 verifies success of the UE parameters update (optional step 2420).

One technical benefit of the UE parameters update procedure as described above for method 2400 is that usage of the UPU Header is defined for deriving an enhanced AUSF MAC (e.g., Enhanced UPU-MAC-I_{AUSF}). For example, AUSF 210 derives an enhanced AUSF MAC based on the UPU Header, and a conventional AUSF MAC. Both the enhanced AUSF MAC and the conventional AUSF MAC are provided to the UE 106. Thus, AUSF 210 and UE 106 may derive or compute the conventional AUSF MAC or the enhanced AUSF MAC in the same way so that the UE parameters update can be verified.

In FIG. 29, the UPU Security Information 2900 may have a structured data type as provided for the Nausf_UPU Protection Service API, as described in section 6.3 of 3GPP TS 29.509. In an embodiment, the enhanced AUSF MAC attribute 2932 is an extension to the structured data type of the UPU Security Information 2900. Provided herein is a revision or extension to the “UpuSecurityInfo” data type as in section 6.3.6.2.3 of 3GPP TS 29.509, in one embodiment. FIG. 36 illustrates a modified “UpuSecurityInfo” data type 3600 for the Nausf_UPU Protection Service API in an illustrative embodiment. As in 6.3.6.2.3 of 3GPP TS 29.509, modified “UpuSecurityInfo” data type 3600 for the Nausf_UPU Protection Service API includes the following attributes: “upuMacIausf”, “counterUpu”, and “upuXmacIue”. In addition, modified “UpuSecurityInfo” data type 3600 further includes “enhancedUpuMacIausf” attribute 3602 as an extension to the “UpuSecurityInfo” data type as in section 6.3.6.2.3 of 3GPP TS 29.509. The “enhancedUpuMacIausf” attribute 3602 is of type “UpuMac”, and is an example of the enhanced AUSF MAC attribute 2932 described in FIG. 29.

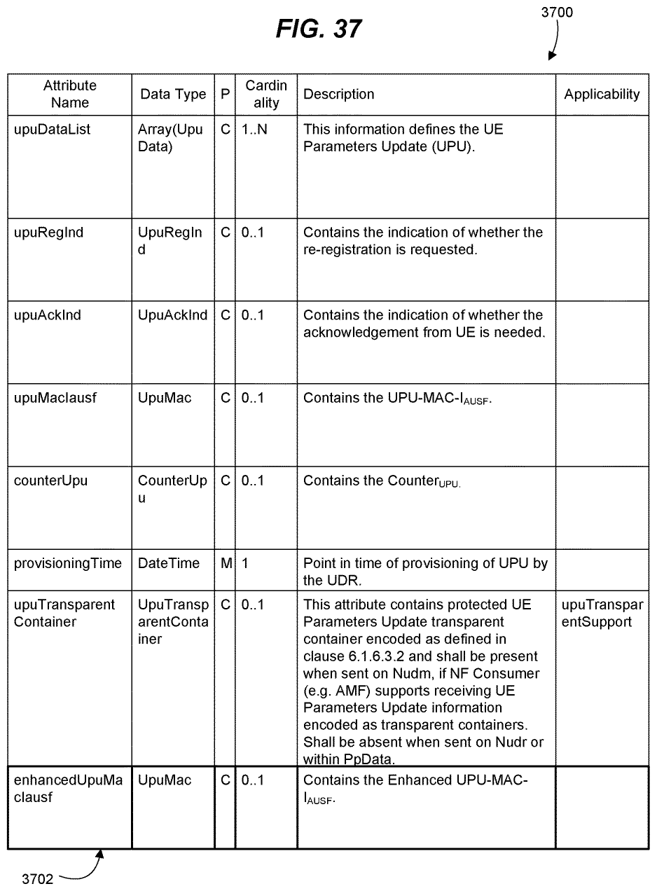

In FIG. 32, the UPU Information 3200 may have a structured data type as provided for the Nudm_SubscriberDataManagement Service API, as described in section 6.1 of 3GPP TS 29.503. In an embodiment, the enhanced UPU information attribute 3236 is an extension to the structured data type of the UPU Information 3200. Provided herein is a revision or extension to the “UpuInfo” data type as in section 6.1.6.2.33 of 3GPP TS 29.503, in one embodiment. FIG. 37 illustrates a modified “UpuInfo” data type 3700 for the Nudm_SubscriberDataManagement Service API in an illustrative embodiment. As in section 6.1.6.2.33 of 3GPP TS 29.503, modified “UpuInfo” data type 3700 for the Nudm_SubscriberDataManagement Service API includes the following attributes: “upuDataList”, “upuRegInd”, “upuAckInd”, “upuMacIausf”, “counterUpu”, “provisioningTime”, and “upuTransparentContainer”. In addition, modified “UpuInfo” data type 3700 further includes “enhancedUpuMacIausf” attribute 3702 as an extension to the “UpuInfo” data type as in section 6.1.6.2.33 of 3GPP TS 29.503. The “enhancedUpuMacIausf” attribute 3702 is of type “UpuMac”, and is an example of the enhanced UPU information attribute 3236 described in FIG. 32.

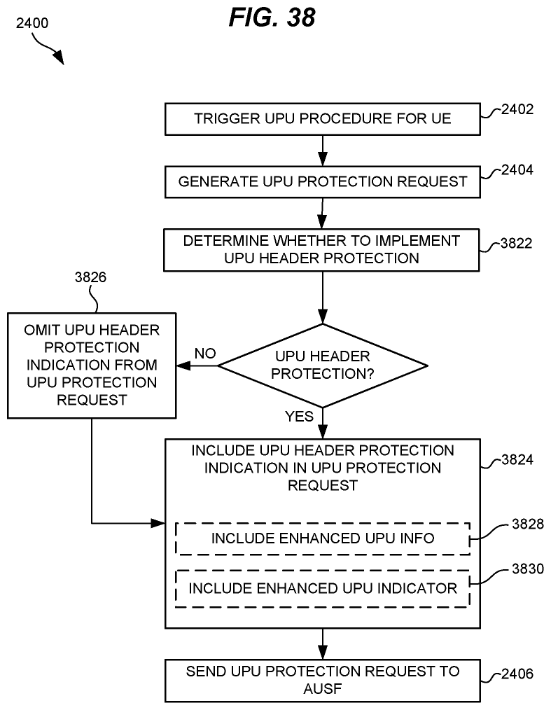

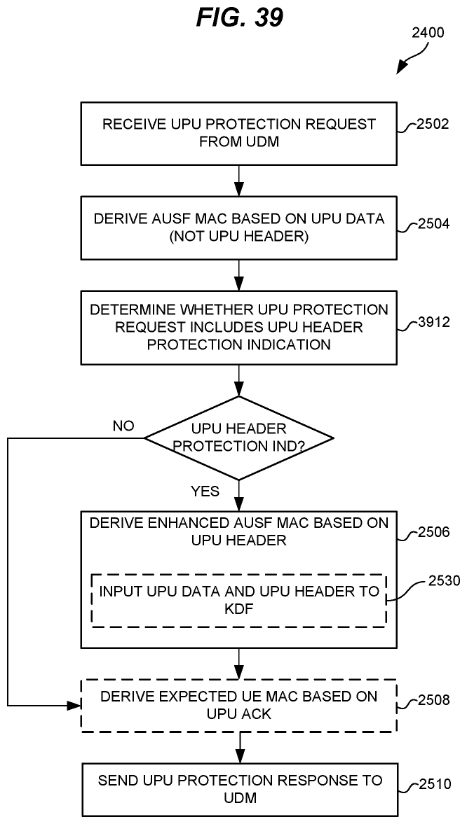

In an embodiment, UDM 218 may signal to AUSF 210 when to derive the enhanced AUSF MAC 2303 in addition to the conventional AUSF MAC 2912. FIGS. 38-39 are flow charts illustrating additional details for method 2400 in an illustrative embodiment. In FIG. 38, data management controller 604 of UDM 218 decides or determines whether to implement UPU header protection (step 3822). When implementing UPU header protection, data management controller 604 of UDM 218 includes or inserts a UPU header protection indication in the UPU protection request message 2801 (step 3824). Including the UPU header protection indication in this manner requests that AUSF 210 derive the enhanced AUSF MAC 2303. For example, data management controller 604 may insert or include enhanced UPU information in the UPU protection request message 2801 (optional step 3828). In another example, data management controller 604 may insert or include an enhanced UPU indicator in the UPU protection request message 2801 (optional step 3830). When not implementing UPU header protection, data management controller 604 of UDM 218 may omit or exclude the UPU header protection indication from the UPU protection request message 2801 (step 3826). Data management controller 604 then sends the UPU protection request message 2801 to AUSF 210 (step 2406), and method 2400 continues as in FIG. 24. One technical benefit is UDM 218 is able to request that AUSF 210 derive the enhanced AUSF MAC 2303 depending on the UPU header protection indication.

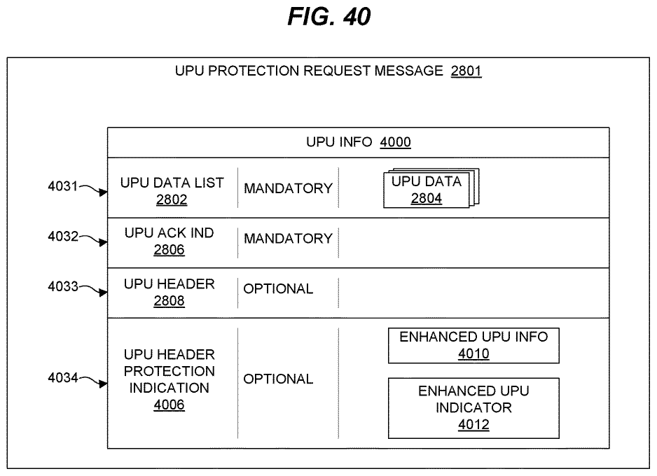

In FIG. 39, authentication controller 704 of AUSF 210 receives the UPU protection request message 2801 from UDM 218 (step 2502) as in FIG. 25, and derives or generates a conventional AUSF MAC based on the UPU Data 2804 and exclusive of the UPU Header 2808 (step 2504). Authentication controller 704 determines whether the UPU protection request message 2801 includes a UPU header protection indication (step 3912). FIG. 40 is a block diagram illustrating a UPU protection request message 2801 for the UPU Protection service in another illustrative embodiment. The UPU protection request message 2801 includes UPU Information 4000 for the UPU Protection service. In FIG. 40, UPU Information 4000 includes the following attributes: a UPU Data List attribute 4031, a UPU acknowledgement indicator attribute 4032, a UPU Header attribute 4033, and a UPU header protection indication attribute 4034. The UPU header protection indication attribute 4034 contains the UPU header protection indication 4006. In an embodiment, the UPU header protection indication 4006 may comprise enhanced UPU information 4010. In an embodiment, the UPU header protection indication 4006 may comprise an enhanced UPU indicator 4012.

In FIG. 39, when the UPU protection request message 2801 includes a UPU header protection indication 4006, authentication controller 704 derives or generates the enhanced AUSF MAC 2303 based on the UPU Header 2808 (step 2506). When the UPU protection request message 2801 does not include a UPU header protection indication 4006, authentication controller 704 skips deriving the enhanced AUSF MAC 2303. Method 2400 may then continue as in FIG. 25.

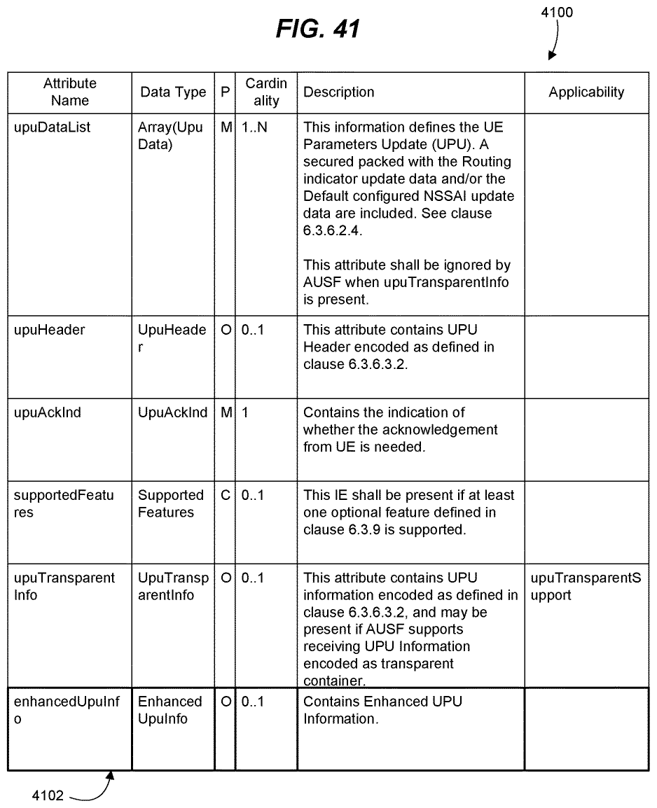

In FIG. 40, the UPU Information 4000 may have a structured data type as provided for the Nausf_UPU Protection Service API, as described in section 6.3 of 3GPP TS 29.509. In an embodiment, the UPU header protection indication attribute 4034 is an extension to the structured data type of the UPU Information 4000. Provided herein is a revision or extension to the “UpuInfo” data type as in section 6.3.6.2.2 of 3GPP TS 29.509, in one embodiment. FIG. 41 illustrates a modified “UpuInfo” data type 4100 for the Nausf_UPU Protection Service API in an illustrative embodiment. As in 6.3.6.2.2 of 3GPP TS 29.509, modified “UpuInfo” data type 4100 for the Nausf_UPU Protection Service API includes the following attributes: “upuDataList”, “upuHeader”, “upuAckInd”, “supportedFeatures”, and “upuTransparentInfo”. In addition, modified “UpuInfo” data type 4100 further includes “enhancedUpuInfo” attribute 4102 as an extension to the “UpuInfo” data type as in section 6.3.6.2.2 of 3GPP TS 29.509. The “enhancedUpuInfo” attribute 4102 is of type “enhancedUpuInfo”, and may include any UPU information as desired.

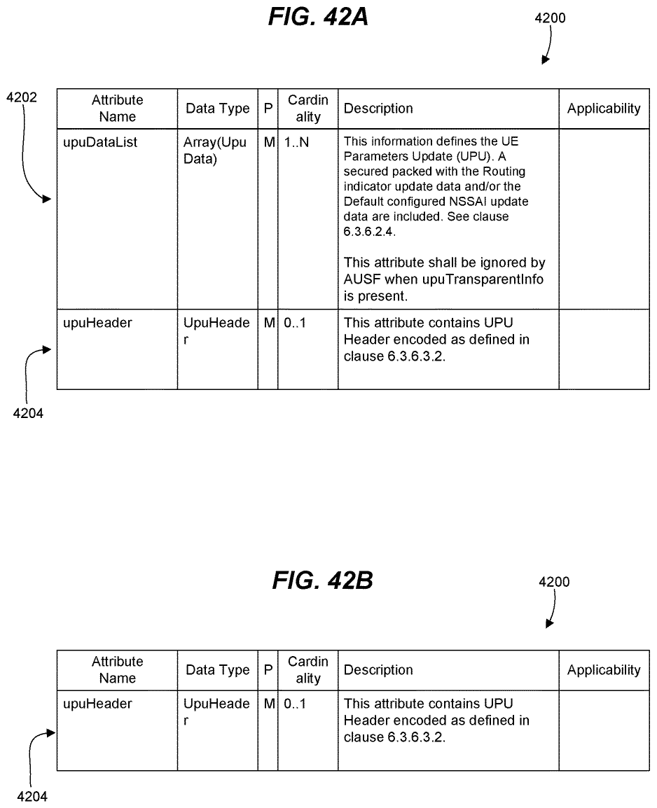

FIG. 42A illustrates an “enhancedUpuInfo” data type 4200 for the Nausf_UPU Protection Service API in an illustrative embodiment. In FIG. 42A, the “enhancedUpuInfo” data type 4200 includes the following attributes: “upuDataList” 4202, and “upuHeader” 4204. The “upuDataList” attribute 4202 comprises an array of “UpuData” as in section 6.3.6.2.4 of 3GPP TS 29.509. The “upuHeader” attribute 4204 is mandatory in this embodiment, and contains the “UPU Header” IE as specified in section 9.11.3.53A of 3GPP TS 24.501. FIG. 42B illustrates an “enhancedUpuInfo” data type 4200 for the Nausf_UPU Protection Service API in an illustrative embodiment. In FIG. 42B, the “enhancedUpuInfo” data type 4200 includes the following attribute: “upuHeader” 4204. The “upuHeader” attribute 4204 is mandatory in this embodiment, and contains the “UPU Header” IE as specified in section 9.11.3.53A of 3GPP TS 24.501. The “enhancedUpuInfo” data type 4200 as in FIG. 42A and/or FIG. 42B may be added to section 6.3 of 3GPP TS 29.509. Also, “enhancedUpuInfo” data type 4200 may replicate the “UpuInfo” data type as in section 6.3.6.2.2 of 3GPP TS 29.509, except with the “upuHeader” attribute 4204 being mandatory.

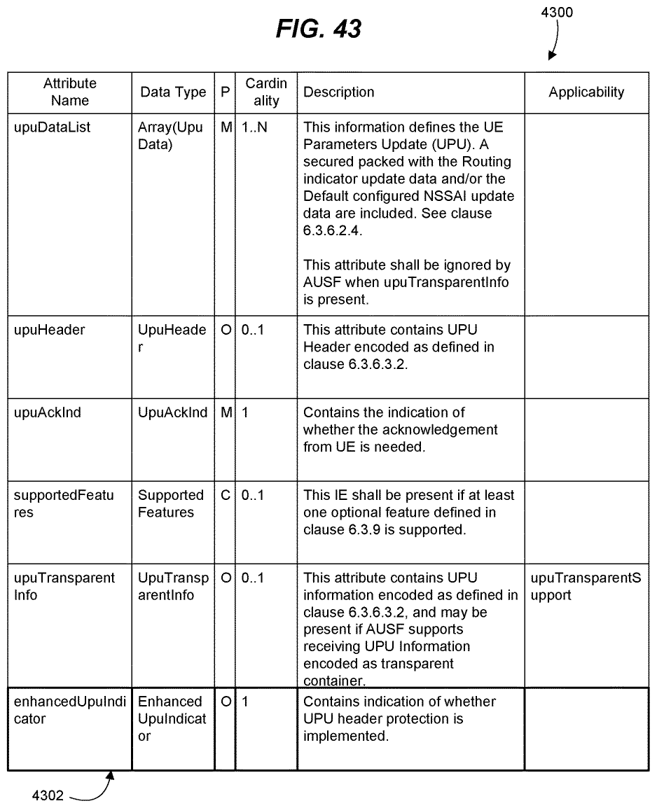

FIG. 43 illustrates another modified “UpuInfo” data type 4300 for the Nausf_UPU Protection Service API in an illustrative embodiment. As in 6.3.6.2.2 of 3GPP TS 29.509, modified “UpuInfo” data type 4300 for the Nausf_UPU Protection Service API includes the following attributes: “upuDataList”, “upuHeader”, “upuAckInd”, “supportedFeatures”, and “upuTransparentInfo”. In addition, modified “UpuInfo” data type 4300 further includes “enhancedUpuIndicator” attribute 4302 as an extension to the “UpuInfo” data type as in section 6.3.6.2.2 of 3GPP TS 29.509. The “enhancedUpuIndicator” attribute 4302 is of type “enhancedUpuIndicator”, and indicates whether UPU header protection is implemented.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

1-14. (canceled)

15. An apparatus for a 5G core network, the apparatus comprising:
at least one processor; and
at least one memory storing instructions of an Authentication Server Function (AUSF) of the 5G core network, wherein the instructions, when executed by the at least one processor, cause the apparatus at least to:
receive, from a unified data management (UDM) element of the 5G core network, a during a UE parameters update (UPU) procedure for updating one or more user equipment parameters in a user equipment or in a Universal Subscriber Identity Module (USIM) of the user equipment, a UPU protection request message, wherein the UPU protection request message includes UPU information comprising UPU data and a UPU header;
determine whether the user equipment supports UPU header protection in derivation of message authentication codes based on a UPU header protection indicator in the UPU protection request message;
derive a message authentication code based on the UPU header when the UPU header protection indicator indicates that the user equipment supports UPU header protection; and
send, to the UDM element, a UPU protection response message in response to the UPU protection request message that includes the message authentication code.

16. The apparatus of claim 15, wherein the instructions, when executed by the at least one processor, further cause the apparatus at least to:
derive the message authentication code based on the UPU data and exclusive of the UPU header when the UPU header protection indicator indicates that the user equipment does not support UPU header protection.

17. The apparatus of claim 15, wherein the instructions, when executed by the at least one processor, further cause the apparatus at least to:
input the UPU data and the UPU header to a key derivation function to derive the message authentication code, when the UPU header protection indicator indicates that the user equipment supports UPU header protection.

18. An apparatus for a 5G core network, the apparatus comprising:
at least one processor; and
at least one memory storing instructions of a Unified Data Management element of the 5G core network, wherein the instructions, when executed by the at least one processor, cause-the apparatus at least to:
during a UE parameters update (UPU) procedure for updating one or more user equipment parameters in a user equipment or in a Universal Subscriber Identity Module (USIM) of the user equipment:
generate a UPU protection request message that includes first UPU information comprising UPU data and a UPU header;
determine whether the user equipment supports UPU header protection in derivation of message authentication codes;
set, when the user equipment supports UPU header protection, a UPU header protection indicator in the UPU protection request message to a first value indicating that the user equipment supports UPU header protection;
set, when the user equipment does not support UPU header protection, the UPU header protection indicator in the UPU protection request message to a second value or omitting the UPU header protection indicator to indicate that the user equipment does not support UPU header protection; and
send, to an Authentication Server Function (AUSF) of the 5G core network, the UPU protection request message.

19. The apparatus of claim 18, wherein the instructions, when executed by the at least one processor, further cause the apparatus at least to:
receive the UPU header protection indicator during primary authentication of the user equipment.

20. The apparatus of claim 18, wherein the instructions, when executed by the at least one processor, further cause the apparatus at least to:
receive, from the AUSE, a UPU protection response message in response to the UPU protection request message, the UPU protection response message comprising a message authentication code;
generate a subscriber data management notification message that includes second UPU information comprising the message authentication code and the UPU data; and
send, to an Access and Mobility Management Function (AMF) of the 5G core network, the subscriber data management notification message

21. A user equipment comprising:
at least one processor; and
at least one memory storing instructions that, when executed by the at least one processor, cause the user equipment at least to perform:
receiving, from an Access and Mobility Management Function (AMF) of a 5G core network, a downlink transport message during a UE parameters update (UPU) procedure for updating one or more user equipment parameters in the user equipment or in a Universal Subscriber Identity Module (USIM) of the user equipment, wherein the downlink transport message includes a UPU transparent container comprising UPU data, a UPU header, and a first message authentication code generated by an Authentication Server Function (AUSF) of the 5G core network;
deriving, when the user equipment supports UPU header protection in derivation of message authentication codes, a second message authentication code based on the UPU header;
comparing the second message authentication code with the first message authentication code; and
updating the user equipment parameters in the user equipment based on the UPU data or forwarding UPU data to the USIM for updating the user equipment parameters based on the UPU data when the second message authentication code matches the first message authentication code.

22. The user equipment of claim 21, wherein the instructions, when executed by the at least one processor, further cause the user equipment at least to perform:
deriving, when the user equipment does not support UPU header protection, the second message authentication code based on the UPU data and exclusive of the UPU header.

23. The user equipment of claim 21, wherein the deriving comprises:
inputting the UPU data and the UPU header to a key derivation function to derive the second message authentication code, when the user equipment supports UPU header protection.

24. The user equipment of claim 21, wherein the instructions, when executed by the at least one processor, further cause the user equipment at least to perform:
prior to the UE parameters update procedure:
inserting a UPU header protection indicator in a control plane message directed to the 5G core network, wherein the UPU header protection indicator indicates whether the user equipment supports UPU header protection; and
sending the control plane message to the AMF.

25. The user equipment of claim 24, wherein the inserting comprises:
inserting the UPU header protection indicator in an initial non-access stratum message.

26. The user equipment of claim 24, wherein the inserting comprises:
inserting the UPU header protection indicator in a registration request provided during primary authentication of the user equipment.
